(19) United States
(12) Patent Application Publication
(10) Pub. No.: US 2026/0010949 A1
(43) Pub. Date: Jan. 8, 2026

(54) IMPROVED METHOD FOR BUYING AND SELLING STOCKS AND SECURITIES

(71) Applicant: Robert Schaaf, St. Joseph, MO (US)

(72) Inventor: Robert Schaaf, St. Joseph, MO (US)

(21) Appl. No.: 18/762,172

(22) Filed: Jul. 2, 2024

(51) Int. Cl. G06Q 40/04; G06Q 40/06

(52) U.S. Cl. CPC G06Q 40/04; G06Q 40/06

(57) ABSTRACT

The present invention provides improved methods for predicting the future price levels of a traded stock, commodity, index, foreign exchange (forex), or other asset. Advantageously, the invention provides results in graphical charts that are readily understood. By using the improved methods of the invention, stock technical analysts and traders can make better informed decisions about when to purchase or sell a stock, security, or other asset.

### FIELD OF THE INVENTION

The present invention relates to improved business methods of buying and selling stocks and securities.

### BACKGROUND OF THE INVENTION

Stock market forecasting and analysis systems and tools are well-known and have been used in various forms for many years. Currently, stock technical analysts and traders use various tools and methods to try to determine when to place buy or sell orders. In general, these tools and methods attempt to predict the market behavior of stocks and securities, so that the user is better informed and can make more profitable decisions about when to purchase or sell a stock or security. But these methods are relatively rudimentary and better ones are desirable.

### SUMMARY OF THE INVENTION

The invention provides improved methods of predicting the future price levels of a traded stock, commodity, index, foreign exchange (forex), or other assets where trades are more likely to be profitable by revealing the likely support and resistance levels in the market. Advantageously, the invention can use either the high, low, or closing prices of an asset to predict the likely support and resistance levels. The invention functions in a similar manner using data sets that comprise high, low, or closing prices or combinations thereof. Also advantageously, the invention can use data consisting of any time series available whether each time increment is a minute, hour, day, week, month, year, or any other time period that is selected by a user.

The invention provides an improved computer-based method for analyzing stock and securities pricing information that comprises using a processor or microprocessor coupled to a memory and a display, such as a computer monitor screen, wherein the processor or microprocessor and memory are programmed to analyze stock and securities price information by receiving sequential price values for a stock (or security). Each set of price values represents a specific time segment of a larger time period. The price values comprise either high, low, or closing prices for the stock (or security). The results of the analysis are graphically displayed on the monitor screen for a user.

Those of skill in the art will appreciate that the number of specific time segments that are selected and the number of calculated price values can be varied as a user desires. For example, as few as two time periods and two data points can be used to predict a future price level for a traded stock, commodity, index, foreign exchange (forex), or other asset.

In a preferred version, the invention uses the initial set of price values that are received to first create two (2) to forty-nine (49), more preferably forty-eight (48), recursive line value variables, with twenty-four (24) of the recursive line value variables representing support lines and twenty-four (24) of the recursive line value variables representing resistance lines, and to create 48 corresponding recursive line value variables for extreme values, one for each line, and 48 corresponding recursive variables for crossing indictors, that is, one for each line. Next, a corresponding numerical factor (an associated factor) is assigned to each recursive support line variable and to each recursive resistance line variable such that the set of support line variables are assigned the same set of factors as the set of resistance line variables, with each set's members assigned 24 different factors including the number zero (0) and twenty three other factors represented by the number 2 raised to the power of zero or a negative power from minus 1 through minus 12 beginning with minus 1 and decreasing by increments of one-half through minus 12 (i.e. 2⁰, 2^{-1.0}, 2^{-1.5}, 2^{-2.0}, 2^{-2.5}, 2^{-3.0}, 2^{-3.5}, 2^{-4.0}, 2^{-4.5}, 2^{-5.0}, 2^{-5.5}, 2^{-6.0}, 2^{-6.5}, 2^{-7.0}, 2^{-7.5}, 2^{-8.0}, 2^{-8.5}, 2^{-9.0}, 2^{-9.5}, 2^{-10.0}, 2^{-10.5}, 2^{-11.0}, 2^{-11.5}, and 2^{-12.0}). Skilled artisans will recognize that the initial set of price values can be used to create either more or fewer recursive line value variables in practicing the invention.

More specifically, the invention provides an improved computer-based method for analyzing stock and securities pricing information, comprising (a) coupling a processor or microprocessor to a memory and a display, wherein the processor or microprocessor is programmed to receive price values for a stock or a security; (b) receiving a set of initial price values for the stock or security that comprise a high price value and a low price value at which the stock or security traded during an initial time period; (c) creating a support line variable and a resistance line variable, wherein the support line variable and the resistance line variable are recursive; (d) creating a crossing indicator variable and an extreme variable for the support line variable and a crossing indicator variable and an extreme variable for the resistance line variable, wherein each crossing indicator variable and each extreme variable is recursive; (e) selecting an associated factor for the support line variable and an associated factor for the resistance line variable, wherein each associated factor is selected from a group of values between zero and one inclusively, and the values of the associated factor for the support line variable and the resistance line variable are the same; (f) giving each crossing indicator variable a value of 1 for the initial time period; (g) using the set of initial price values to give the extreme variable for the support line variable an assigned received high price value for the initial time period; (h) using the set of initial price values to give the extreme variable for the resistance line variable a designated received low price value for the initial time period; (i) using the set of initial price values to give the support line variable an assigned received low price value for the initial time period; (j) using the set of initial price values to give the resistance line variable a designated received high price value for the initial time period; (k) receiving at least one set of subsequent price values for the stock or security that comprises the high price value and the low price value at which the stock or security traded during a subsequent time period; (l) using the set of subsequent price values to compute a subsequent support line segment and a subsequent resistance line segment for a current time period, wherein the subsequent support line segment and the subsequent resistance line segment comprise values computed respectively for the support line variable and the resistance line variable, and plotting a graphical temporal display of the support line and the resistance line for at least one previous time period and the current time period; (m) using the set of subsequent price values to give the crossing indicator variable for the support line variable an assigned value of zero or one for the current time period, wherein an absolute value of the difference between the assigned value given to the extreme variable for the support line variable for an immediately preceding time period and the assigned value given to the support line variable for the immediately preceding time period is calculated to yield an assigned result that is multiplied by the associated factor given to the support line variable to yield an assigned product that is added to the assigned value given to the support line variable from the immediately preceding time period to yield a projected support line value such that if the projected support line value is greater than or equal to the assigned received low price value for the current time period, then the crossing indicator variable for the support line variable is given the assigned value of one for the current time period, and if the projected support line value is less than the assigned received low price value for the current time period, then the crossing indicator variable for the support line variable is given the value of zero for the current time period; (n) using the set of subsequent price values to give to the crossing indicator variable for the resistance line variable a designated value of zero or one for the current time period, wherein an absolute value of the difference between the designated value given to the extreme variable for the resistance line variable for the immediately preceding time period and the designated value given to the resistance line variable for the immediately preceding time period is calculated to yield a designated result that is multiplied by the associated factor given to the resistance line variable to yield a designated product that is subtracted from the designated value given to the resistance line variable for the immediately preceding time period to yield a projected resistance line value such that if the projected resistance line value is less than or equal to the designated received high price value, then the crossing indicator variable for the resistance line variable is given the designated value of one for the current time period, and if the projected resistance line value is greater than the designated received high price value, then the crossing indicator variable for the resistance line variable is given the value of zero for the current time period; (o) using the set of subsequent price values to give to the extreme variable for the support line variable an assigned value for the current time period, wherein if the crossing indicator variable for the support line variable was given the assigned value of one for the current time period, then the extreme variable for the support line variable is given the assigned received high price value for the current time period, and if the crossing indicator variable for the support line variable was given a value of zero for the current time period, then if the assigned received high price value for the current time period is greater than the assigned value for the extreme variable for the support line variable for the immediately preceding time period, then the extreme variable for the current time period is given the assigned received high price value, and if the assigned received high price value for the current time period is less than or equal to the assigned value given to the extreme variable for the support line variable for the immediately preceding time period, then the extreme variable for the support line variable is given the same assigned value for the current time period as was given to the extreme variable for the support line variable for the immediately preceding time period; (p) using the set of subsequent price values to give to the extreme variable for the resistance line variable a designated current value for the current time period such that if the crossing indicator variable for the resistance line variable was given the designated value of one for the current time period, then the extreme variable for the resistance line variable is given a designated received low price value for the current time period, and if the crossing indicator variable for the resistance line variable was given the designated value of zero for the current time period, then if the designated received low price value for the current time period is less than the designated value given to the extreme variable for the resistance line variable for the immediately preceding time period, then the extreme variable for the resistance line variable for the current time period is given the designated received low price value, and if the designated received low price value for the current time period is greater than or equal to the designated value given for the extreme variable for the resistance line variable for the immediately preceding time period, then the extreme variable for the resistance line variable is given the same value for the current time period as was given to the extreme variable for the resistance line variable for the immediately preceding time period; (q) using the set of subsequent price values to give to the support line variable an assigned value for the current time period such that if the crossing indicator variable for the support line variable was given the assigned value of one for the current time period, then the support line variable is given the assigned received low price value for the current time period, and if the crossing indicator variable for the support line variable was given the assigned value of zero for the current time period, then the absolute value of the difference between the assigned value given to the extreme variable for the support line variable for the current time period and the assigned value given to the support line variable for the immediately preceding time period is calculated to yield an assigned result that is multiplied by the associated factor given to the support line variable to yield an assigned product that is added to the assigned value given to the support line variable for the immediately preceding time period to yield an assigned final result that is given to the support line variable for the current time period; (r) using the set of subsequent price values to give to the resistance line variable a designated value for the current time period such that if the crossing indicator variable for the resistance line variable was given the designated value of one for the current time period, then the resistance line variable is given the designated received high price value for the current time period, and if the crossing indicator variable for the resistance line variable was given a designated value of zero for the current time period, then the absolute value of the difference between the designated value given to the extreme variable for the resistance line variable for the current time period and the designated value given to the resistance line variable for the immediately preceding time period is calculated to yield a designated result that is multiplied by the associated factor given to the resistance line variable to yield a designated product that is subtracted from the designated value given to the resistance line variable for the immediately preceding time period to yield a designated final result that is given to the resistance line variable for the current time period; and(s) plotting a subsequent support line segment for the support line variable and a subsequent resistance line segment for the resistance line variable on a price chart such that for the support line variable and the resistance line variable if the respective crossing indicator variable was given a value of one for the current time period, then the support line segment or the resistance line segment is not plotted on the price chart for the current time period, and if the respective crossing indicator variable was given a value of zero for the current time period, then the subsequent support line segment or the subsequent resistance line segment is plotted on the price chart for the current time period such that the subsequent support line segment is plotted to extend from the assigned value given to the support line variable for the immediately preceding time period to the assigned value given to the support line variable for the current time period, and the subsequent resistance line segment is plotted to extend from the designated value given to the resistance line variable for the immediately preceding time period to the designated value given to the resistance line variable for the current time period.

Advantageously, an initial period of time can consist of minutes, hours, days, weeks, months, years, or a combination thereof. Subsequent periods of time can also consist of minutes, hours, days, weeks, months, years, or a combination thereof as a user desires.

The invention further provides for (a) receiving at least one additional set of subsequent price values for a stock or security for at least one additional time period wherein each set of subsequent price values for the stock or security comprises a high price value and a low price value at which the stock or security traded during a subsequent time period; (b) using the additional set of subsequent price values to compute a subsequent support line segment and a subsequent resistance line segment for a current time period, wherein the subsequent support line segment and the subsequent resistance line segment comprise values computed for the support line variable and the resistance line variable, and plotting a graphical temporal display of the support line and the resistance line for at least one previous time period and the current time period; (c) using the additional set of subsequent price values to give to the crossing indicator variable for the support line variable an assigned value of zero or one for the current time period, wherein an absolute value of the difference between the assigned value given to the extreme variable for the support line variable for an immediately preceding time period and the assigned value given to the support line variable for the immediately preceding time period is calculated to yield an assigned result that is multiplied by the associated factor given to the support line variable to yield an assigned product that is added to the assigned value given to the support line variable for the immediately preceding time period to yield a projected support line value such that if the projected support line value is greater than or equal to the assigned received low price value for the current time period, then the crossing indicator variable for the support line variable is given the assigned value of one for the current time period, and if the projected support line value is less than the assigned received low price value for the current time period, then the crossing indicator variable for the support line variable is given the assigned value of zero for the current time period; (d) using the additional set of subsequent price values to give to the crossing indicator variable for the resistance line variable a designated value of zero or one for the current time period, wherein the absolute value of the difference between the designated value given to the extreme variable for the resistance line variable for the immediately preceding time period and the designated value given to the resistance line variable for the immediately preceding time period is calculated to yield a designated result that is multiplied by the associated factor given to the resistance line variable to yield a designated product that is subtracted from the designated value given to the resistance line variable for the immediately preceding time period to yield a projected resistance line value such that if the projected resistance line value is less than or equal to the designated received high price value, then the crossing indicator variable for the resistance line variable is given the designated value of one for the current time period, and if the projected resistance line value is greater than the designated received high price value, then the crossing indicator variable for the resistance line variable is given the designated value of zero for the current time period; (e) using the additional set of subsequent price values to give to the extreme variable for each support line variable the assigned value for the current time period, wherein if the crossing indicator variable for the support line variable was given the assigned value of one for the current time period, then the extreme variable for each support line variable is given the assigned received high price value for the current time period, and if the crossing indicator variable for the support line variable was given the value of zero for the current time period, then if the assigned received high price value for the current time period is greater than the assigned value given to the extreme variable for the support line variable for the immediately preceding time period, then the extreme variable for the support line variable for the current time period is given the assigned received high price value, and if the assigned received high price value for the current time period is less than or equal to the assigned value given to the extreme variable for the support line variable for the immediately preceding time period, then the extreme variable for the support line variable is given the same value for the current time period as was given to the extreme variable for the support line variable for the immediately preceding time period; (f) using the additional set of subsequent price values to give to the extreme variable for the resistance line variable the designated value for the current time period such that if the crossing indicator variable for the resistance line variable was given the designated value of one for the current time period, then the extreme variable for the resistance line variable is given the designated received low price value for the current time period, and if the crossing indicator variable for the resistance line variable was given the value of zero for the current time period, then if the designated received low price value for the current time period is less than the designated value given to the extreme variable for the resistance line variable for the immediately preceding time period, then the extreme variable for the resistance line variable for the current time period is given the designated received low price value, and if the designated received low price value for the current time period is greater than or equal to the designated value given for the extreme variable for the resistance line variable for the immediately preceding time period, then the extreme variable for the resistance line variable is given the same value for the current time period as was given to the extreme variable for the resistance line variable for the immediately preceding time period; (g) using the additional set of subsequent price values to give to the support line variable an assigned value for the current time period such that if the crossing indicator variable for the support line variable was given the assigned value of one for the current time period, then the support line variable is given the assigned received low price value for the current time period, and if the crossing indicator variable for the support line variable was given the assigned value of zero for the current time period, then the absolute value of the difference between the assigned value given to the extreme variable for the support line variable for the current time period and the assigned value given to the support line variable for the immediately preceding time period is calculated to yield an assigned result that is multiplied by the associated factor given to the support line variable to yield an assigned product that is added to the assigned value given to the support line variable for the immediately preceding time period to yield an assigned final result that is given to the support line variable for the current time period; (h) using the additional set of subsequent price values to give to the resistance line variable a designated value for the current time period such that if the crossing indicator variable for the resistance line variable was given the designated value of one for the current time period, then the resistance line variable is given the designated received high price value for the current time period, and if the crossing indicator variable for the resistance line variable was given a designated value of zero for the current time period, then the absolute value of the difference between the designated value given to the extreme variable for the resistance line variable for the current time period and the designated value given to the resistance line variable for the immediately preceding time period is calculated to yield a designated result that is multiplied by the associated factor given to the resistance line variable to yield a designated product that is subtracted from the designated value given to the resistance line variable for the immediately preceding time period to yield a designated final result that is given to the resistance line variable for the current time period; and (i) plotting the subsequent support line segment for the support line variable and the subsequent resistance line segment for the resistance line variable on a price chart such that for the support line variable and the resistance line variable if the respective crossing indicator variable was given a value of one for the current time period, then the support line segment or the resistance line segment is not plotted on the price chart for the current time period, and if the respective crossing indicator variable was given the value of zero for the current time period, then the subsequent support line segment or the subsequent resistance line segment is plotted on the price chart for the current time period such that the subsequent support line segment is plotted to extend from the assigned value given to the support line variable for the immediately preceding time period to the assigned value given to the support line variable for the current time period, and the subsequent resistance line segment is plotted to extend from the designated value given to the resistance line variable for the immediately preceding time period to the designated value given to the resistance line variable for the current time period.

The invention also provides an improved computer-based method for analyzing stock and securities pricing information of claim 1 that further comprises (a) computing and plotting a final support line segment for a final time period for each support line variable after the subsequent received high price values and the subsequent received low price values are used to calculate and plot the subsequent support line segments, wherein for each support line variable if the respective crossing indicator variable was given the assigned value of one for the immediately preceding time period then the final support line segment for the support line variable is not plotted, and if the respective crossing indicator variable was given the assigned value of zero for the immediately preceding time period then the absolute value of the difference between the assigned value given to the respective extreme variable for the immediately preceding time period and the assigned value given to the support line variable for the immediately preceding time period is calculated and an assigned final result is multiplied by the associated factor given to the support line variable and an assigned final product is added to the assigned value given to the support line variable for the immediately preceding time period, and an assigned final value is given to the support line variable for the final time period; (b) computing and plotting a final resistance line segment for a final time period for each resistance line variable after the subsequent received high price values and the subsequent received low price values are used to calculate and plot subsequent resistance line segments wherein for each resistance line variable if the respective crossing indicator variable was given the designated value of one for the immediately preceding time period then the final resistance line segment for the resistance line variable is not plotted, and if the respective crossing indicator variable was given the designated value of zero for the immediately preceding time period then the absolute value of the difference between the designated value given to the respective extreme variable for the immediately preceding time period and the designated value given to the resistance line variable for the immediately preceding time period is calculated and a designated final result is multiplied by the associated factor given to the resistance line variable and a designated final product is subtracted from the designated value given to the resistance line variable for the immediately preceding time period, and a designated final value is given to the resistance line variable for the final time period; and (c) plotting a final support line segment for the support line variable and a final resistance line segment for the resistance line variable such that if the respective crossing indicator variable for the support line or the resistance line was given the value of one, then the final support line segment or the final resistance line segment is not plotted for a last time period, and if the respective crossing indicator variable for the support line or the resistance line was given the value of zero, then the final support line segment or the final resistance line segment is plotted for the final time period such that the final support line segment for the support line variable is plotted for the last time period to extend from the assigned value given to the support line variable for the immediately preceding time period to the assigned final value given to the support line variable and the final resistance line segment for the resistance line variable is plotted for the last time period to extend from the designated value given to the resistance line variable for the immediately preceding time period to the designated final value given to the resistance line variable.

As line values are sequentially computed, the invention plots the support and resistance lines on a monitor's screen overlying the price chart of the stock or other asset, according to an algorithm wherein, for each support and resistance line, if the line's current crossing indicator variable is assigned a value of one, then the line is not plotted on the price chart for the current period, and if the line's current crossing indicator variable is assigned a value of zero, then the line is plotted on the price chart for the current period, extending from the line's line value for the previous period to the line's line value for the current period. Preferably, all of the lines are plotted using a presentation format consisting of color, line thickness, line segmentation, or a combination thereof to allow for easy identification of the individual lines by the user.

The invention computes and plots a final line segment for each line according to an algorithm, representing where the support and resistance levels are likely to be for the next yet-to-occur trading period; for computing and plotting the final line segment, the term “previous period” will refer to the last time period for which high, low and close data was received; for each support and resistance line, if the line's crossing indicator variable for the previous period was assigned a value of one, a final line segment for the line is not plotted; for each support line, if the line's crossing indicator variable for the previous period was assigned a value of zero, then the absolute value of the difference between the extreme value of the previous period and the line value of the previous period is calculated and the resulting value is multiplied by the line's associated factor and the resulting product is added to the line value of line's previous period, and the result is assigned to the line's line value variable for the final period; for each resistance line, if the line's crossing indicator variable for the previous period was assigned a value of zero, then the absolute value of the difference between the extreme value of the previous period and the line value of the previous period is calculated and the resulting value is multiplied by the line's associated factor and the resulting product is subtracted from the line value of line's previous period, and the result is assigned to the line's line value variable for the final period; for each support and resistance line, if the line's previous crossing indicator variable was assigned a value of one, then the line is not plotted on the price chart for the final period, and if the line's previous crossing indicator variable was assigned a value of zero, then the line is plotted on the price chart for the final period, extending from the line's line value for the previous period to the line's line value for the final period, using the same format as used to graphically display the previously displayed results.

In another embodiment of the invention, the extreme variable for the support line variable is given an assigned received high price value for both the initial time period and subsequent time periods, and the extreme variable for the resistance line variable is given a designated received low price value for the initial time period and subsequent time periods.

In a further embodiment, the extreme variable for the support line variable is given an assigned received low price value for both the initial time period and subsequent time periods, and the extreme variable for the resistance line variable is given a designated received low price value for the initial time period and subsequent time periods.

Another embodiment of the invention provides that the extreme variable for the support line variable is given an assigned received closing price value for both the initial time period and subsequent time periods, and the extreme variable for the resistance line variable is given a designated received closing price value for the initial time period and subsequent time periods.

In another embodiment of the invention, the extreme variable for the support line variable is given an assigned received high price value for both the initial time period and subsequent time periods, and the extreme variable for the resistance line variable is given a designated received high price value for the initial time period and subsequent time periods.

Skilled artisans will understand that one embodiment of the invention may be more suitable or preferred by some users and such preference will depend upon the user's objective(s) and type(s) of traded stock, commodity, index, foreign exchange (forex), or other asset that the user wishes to analyze.

### BRIEF DESCRIPTION OF DRAWINGS

The following drawings form part of the present specification and are included to further demonstrate certain aspects of the invention. The invention may be better understood by reference to one or more of these drawings in combination with the detailed description presented herein. Unless specifically noted, articles depicted in the drawings are not necessarily drawn to scale.

FIG. 1 is an exemplary weekly bar chart showing the Gold Futures prices from February through August of 2017. Bars indicate the opening, high, low, and closing prices for each time period.

FIG. 2 illustrates the same data and time periods as FIG. 1 but computed by using methods of the invention. Solid or dashed black or gray lines indicate the different support lines (below the price bars in FIG. 1) and resistance lines (above the price bars in FIG. 1).

FIG. 3 is an exemplary chart showing the daily stock prices for Twitter (TWTR) from December 2013 through September 2014 using methods of the invention. Solid, broken, or dashed black or gray lines are tagged to demonstrate all 24 support lines and 24 resistance lines.

FIG. 4 is an exemplary chart that illustrates an alternative way to view stock prices showing the weekly closing values for the Dow Jones Industrial Average over a two-year period.

FIG. 5 is a flow chart illustrating how the lines shown in FIGS. 1-4 are computed using high values for support lines and low values for resistance lines (Method 1) or closing values (Method 2).

FIG. 6 is a flow chart illustrating how the lines are computed using low values for support lines and high values for resistance lines (Method 3).

FIG. 7 shows an exemplary daily chart for Apple (AAPL) for 2022.

FIG. 8 shows an exemplary daily chart for Amazon (AMZN) for 2022.

FIG. 9 shows an exemplary daily chart for Google (GOOGL) for 2022.

FIG. 10 shows an exemplary daily chart for Meta (META) for 2022.

FIG. 11 shows an exemplary daily chart for Microsoft (MSFT) for 2022.

FIG. 12 shows an exemplary daily chart for Netflix (NFLX) for 2022.

### DETAILED DESCRIPTION

The invention provides improved methods of predictively charting the price levels of support and resistance of a traded stock, commodity, index, foreign exchange (forex), or other asset. By using the improved methods of the invention, stock technical analysts and traders can make better informed decisions about when to purchase or sell a stock, security, or other asset.

The invention utilizes the price levels of a stock or other asset as they change over time. For ease of discussion, the invention is described using stock prices; however, those of skill in the art will recognize that the described methods are also applicable to commodity, index, forex, or other asset prices that change over time. Herein the terms “support” and “resistance” are used to refer to levels on a price chart that appear to limit a market's range of movement. For example, a support level is where the price is likely to stop falling and rise, and the resistance level is where the price is likely to stop rising and decrease. Thus, the price level of a stock oscillates between the levels of support and resistance, and these levels shift over time in ever changing patterns.

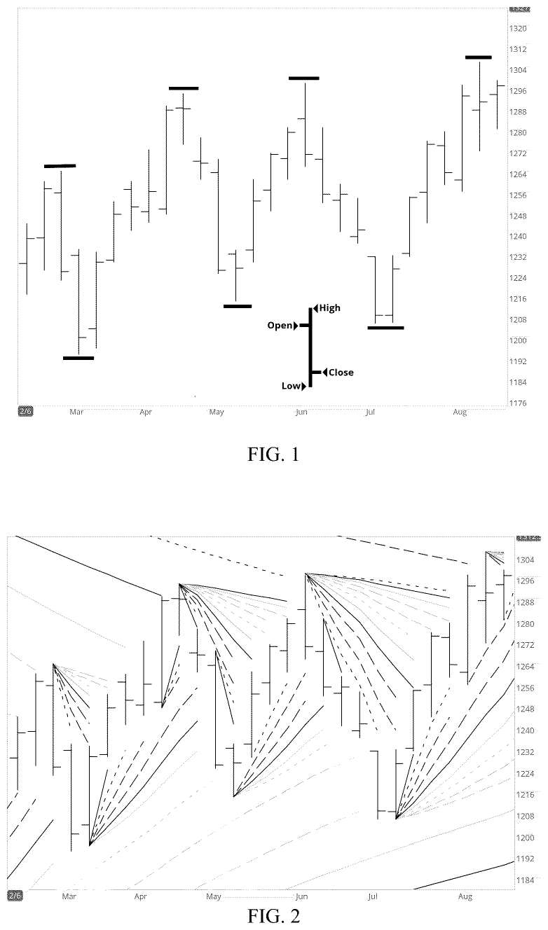

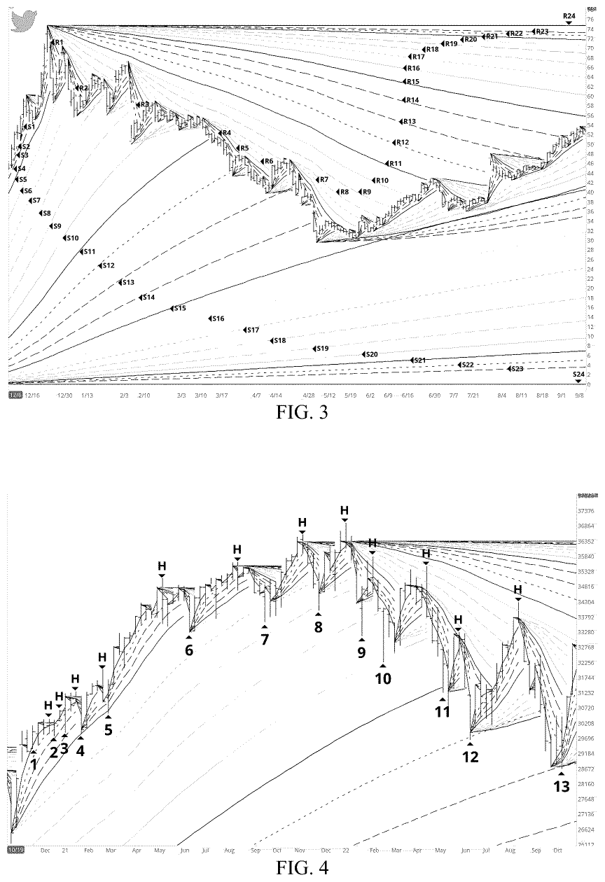

Currently, stock technical analysts and traders use relatively rudimentary methods of determining the levels of likely support and resistance at which to place buy or sell orders. See FIG. 1. In contrast, the invention provides improved methods that create a family of lines drawn on the price chart that visually depicts where the levels of support and resistance are likely to be, and the levels are more accurate than the results obtained with commonly used methods.

Using a more accurate method of determining the levels of support and resistance increases the likelihood of successful trades and increased profits. For example, FIG. 2 illustrates the same data shown in FIG. 1, but in FIG. 2 the data is depicted using a method of the invention that results in families of lines. These resulting families of lines can be plotted on a time series using any time desired period per bar, such as a day, week, month, year, minute, hour, or any other available time unit. In FIG. 2, applying methods of the invention to the data creates 48 lines, with 24 resistance lines above the price curve that are referred to herein as 1R, 2R, 3R, and so on to 24R; and 24 support lines below the price curve that are referred to herein as 1S, 2S, 3S, and so on to 24S.

Those of skill in the art will recognize that the data series of Open, High, Low, Close, and Volume values can be obtained from a data supplier and used for computations in the invention. The resulting data are plotted over the underlying stock chart. But unlike such chart studies, the invention only requires the high and low or closing price values, ignoring other values in the supplied data such as open or volume.

In the invention, each line is computed and drawn separately, with the computation starting at the first set of data elements in whatever time series is chosen, and then each subsequent segment of the line is computed and plotted based upon the corresponding next set of data elements in the series. As the price of the underlying asset rises and falls, each line also moves, with a slope proportional to its assigned factor. Any given line will appear to begin and show on the chart when it is no longer touching a price bar or candle (candlestick) and it will appear to end when it is computed to be at (or touching) a bar or candle.

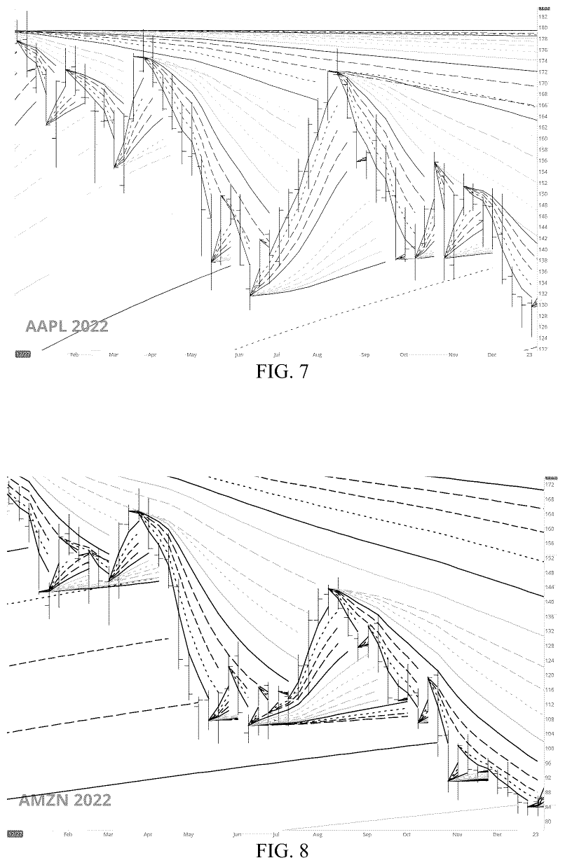

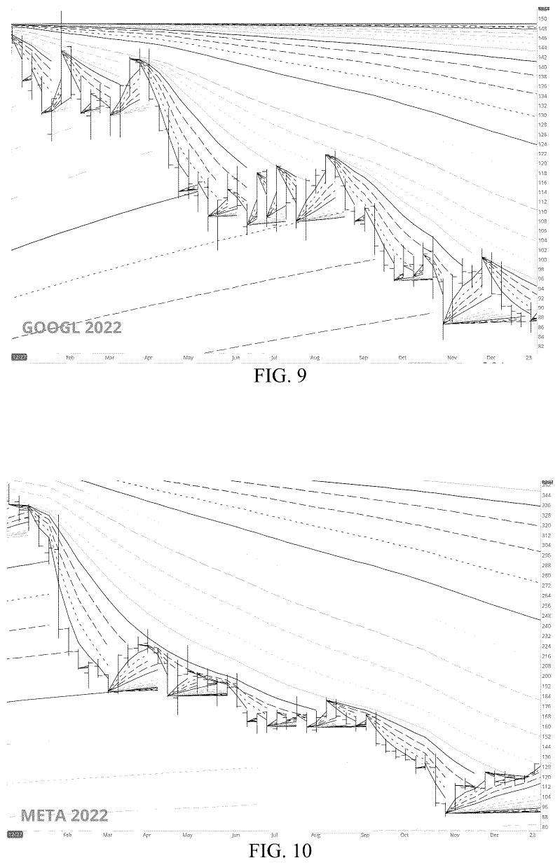

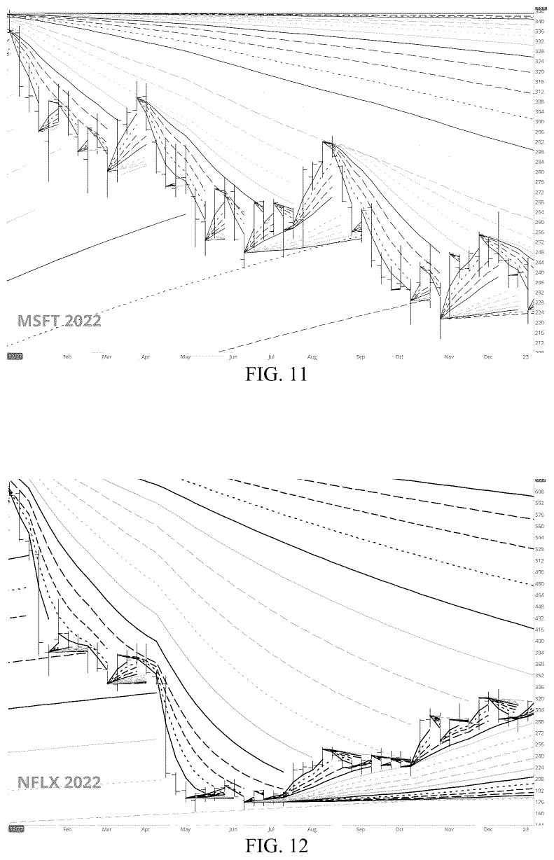

For ease of identification in FIG. 2, FIG. 3, FIG. 4, FIG. 7, FIG. 8, FIG. 9, FIG. 10, FIG. 11, and FIG. 12 solid or broken lines in either gray or black are used for illustration. Those of skill in the art will appreciate that the lines may be more readily understood when presented in color. But for the purposes of this application, color is not used to illustrate the data.

By using a method of the invention, a user can better predict where the levels of support and resistance are likely to be at a given point in real time. While the invention does not allow a user to exactly predict stock prices, it does allow a user to better anticipate where the levels of support and resistance are likely to be at a given point in real time for a specific stock. For example, FIG. 3 illustrates the daily chart of the Twitter (TWTR) stock price from December 2013 to September 2014.

As shown in FIG. 3, a stock's price is more likely to reverse direction near one of the lines. A study of the lines reveals patterns that a stock price is likely to follow as it bounces up and down. Each line has a distinctive common behavior. Each of the lines is assigned a factor as follows: Lines 1R and 1S are assigned the factor 2 raised to the minus 1 power. Lines 2R and 2S are assigned the factor 2 raised to the minus 1.5 power. Lines 3R and 3S are assigned the factor 2 raised to the minus 2 power. Lines 4R and 4S are assigned the factor 2 raised to the minus 2.5 power and so on, until Lines 23R and 23S are assigned the factor 2 raised to the minus 12 power. Lines 24R and 24S are assigned the factor zero, and as a result of having the factor zero, lines 24R and 24S are horizontal.

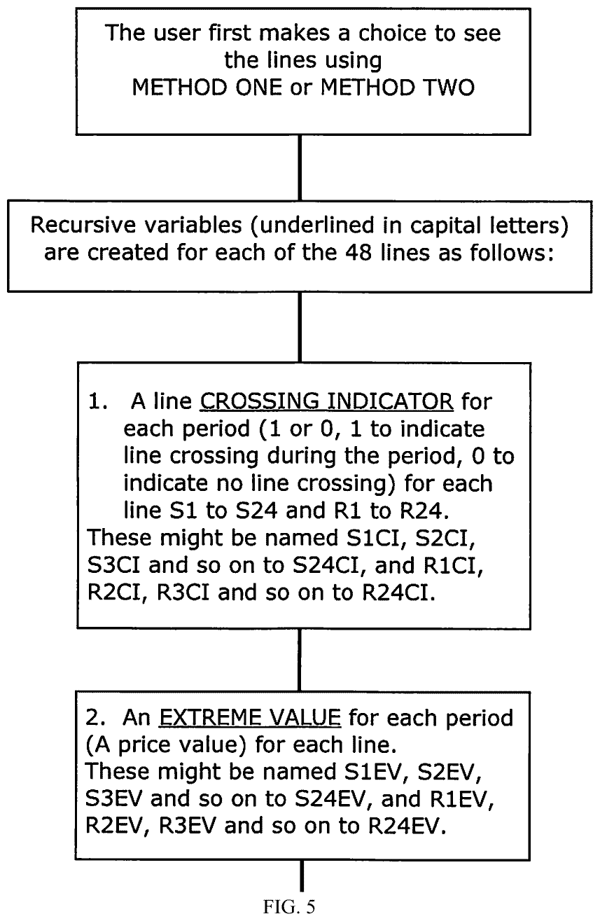

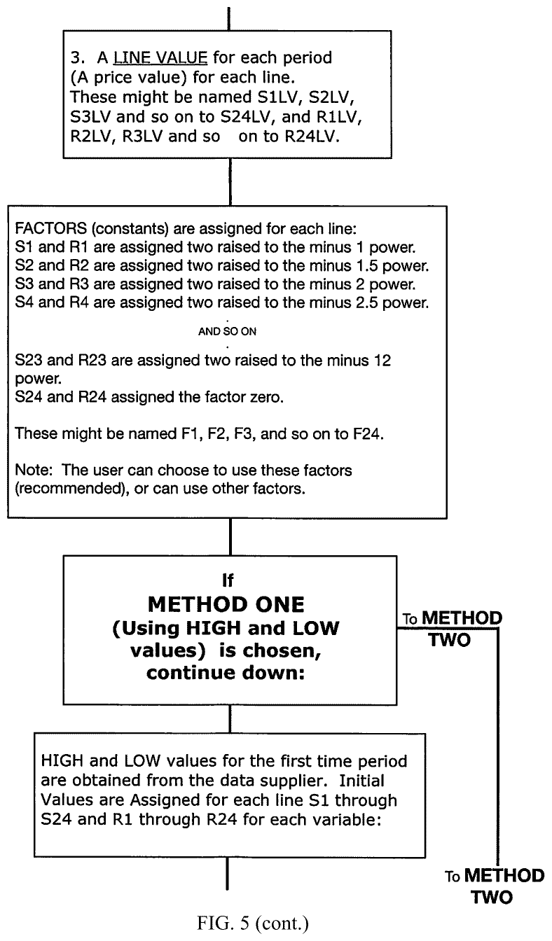

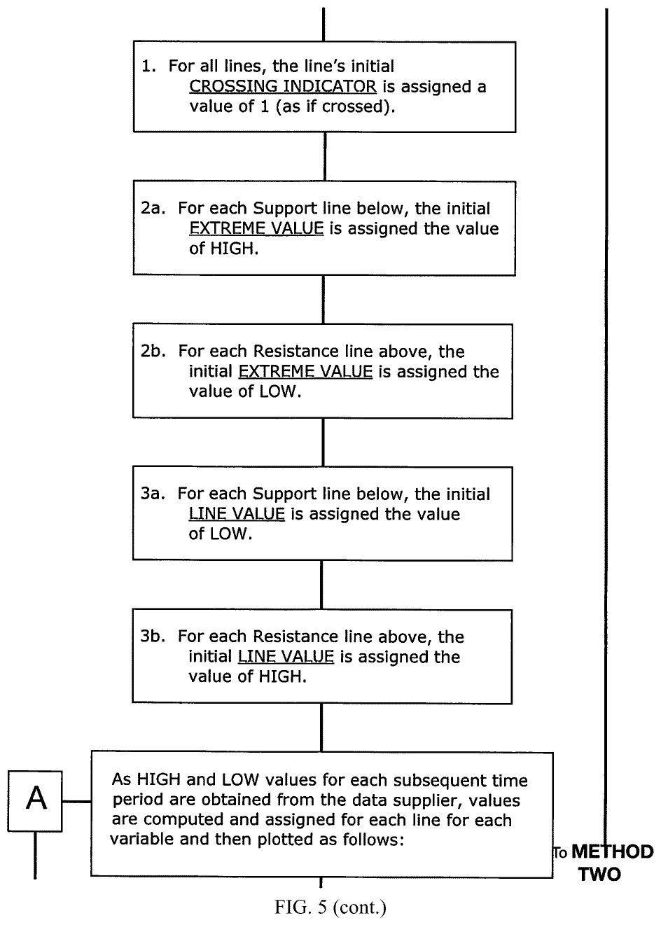

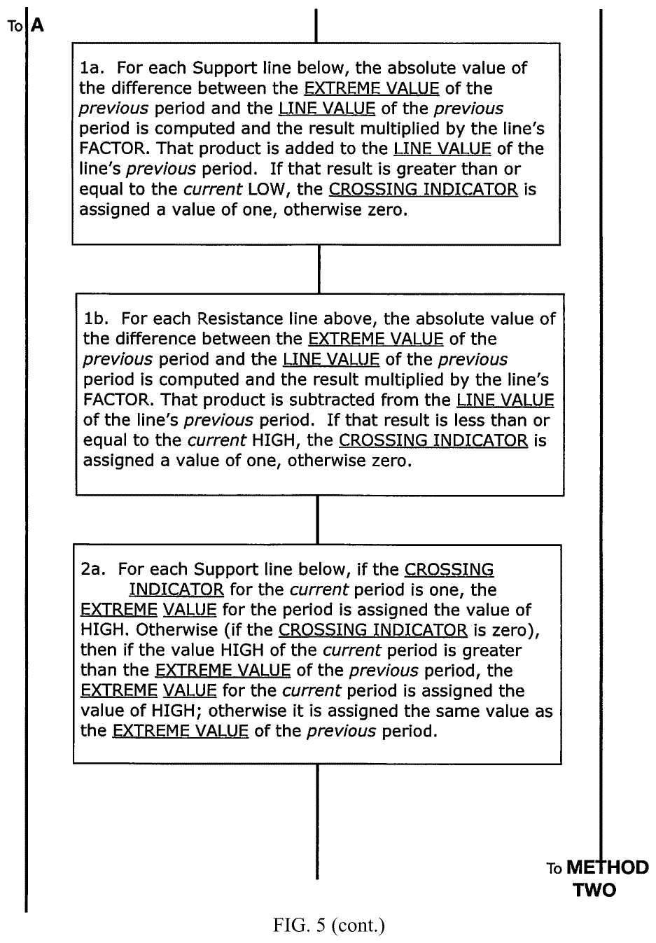

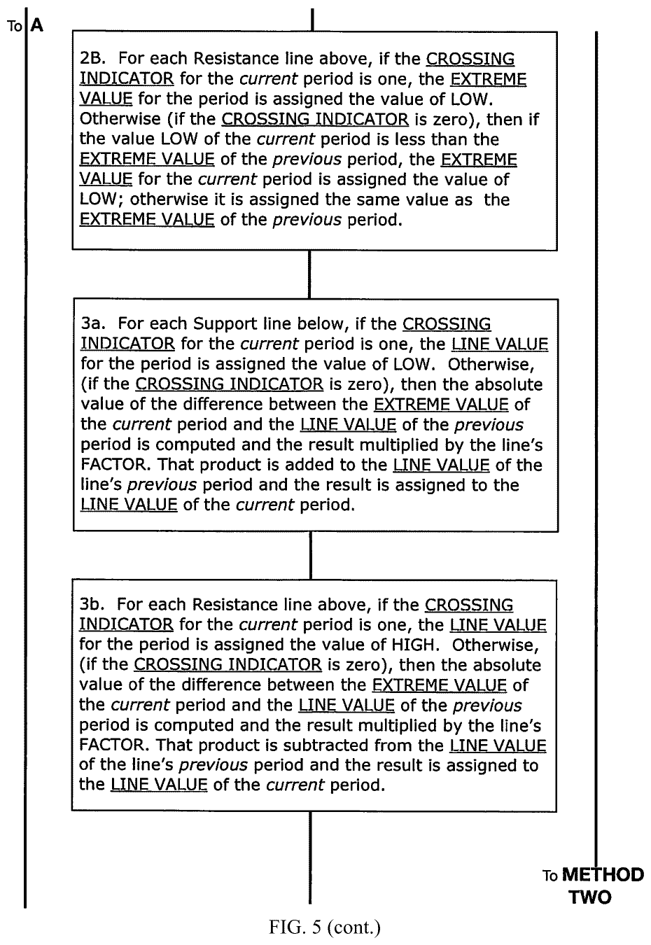

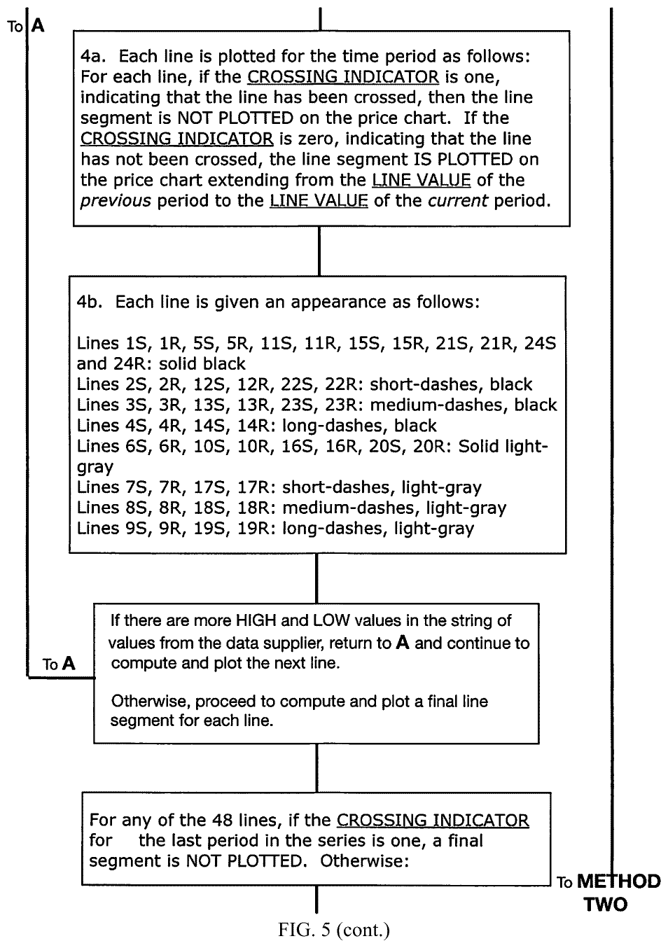

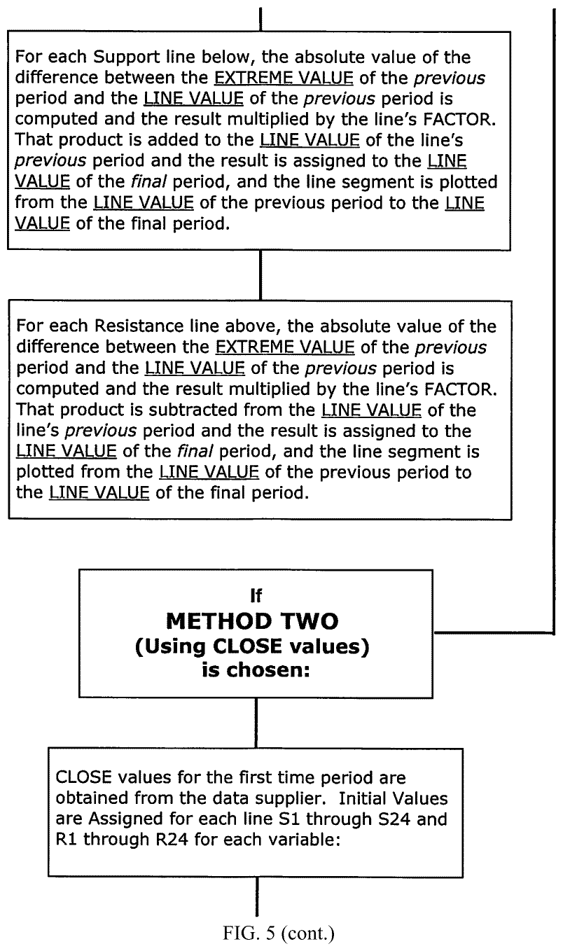

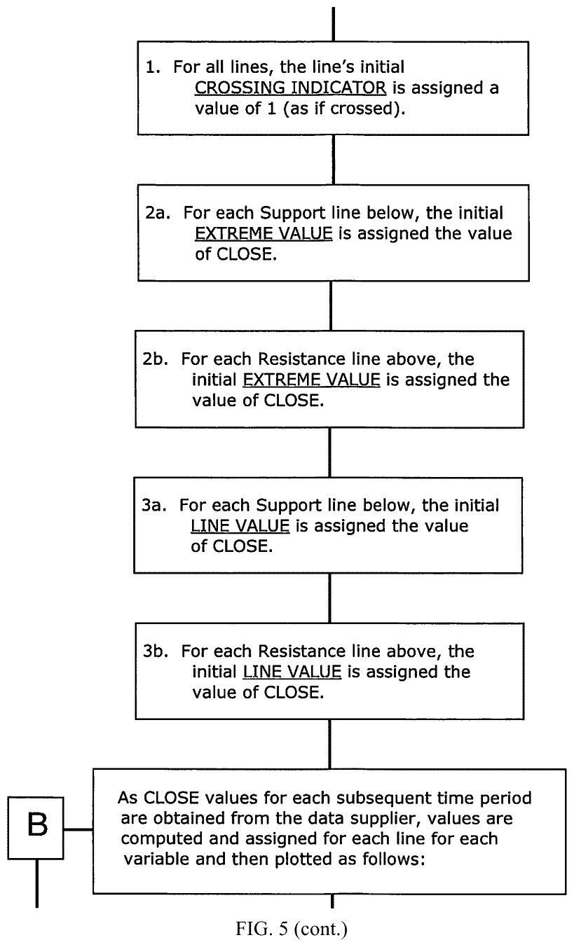

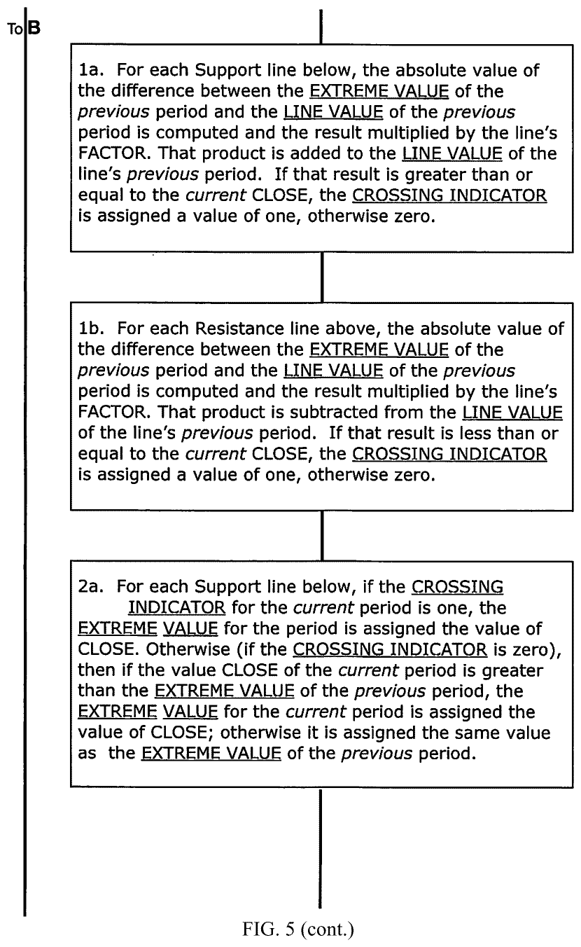

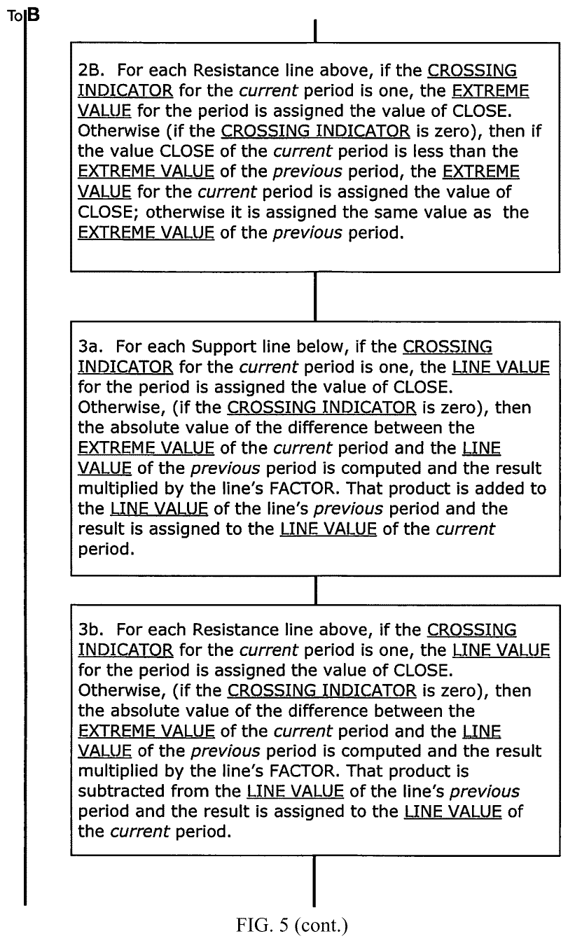

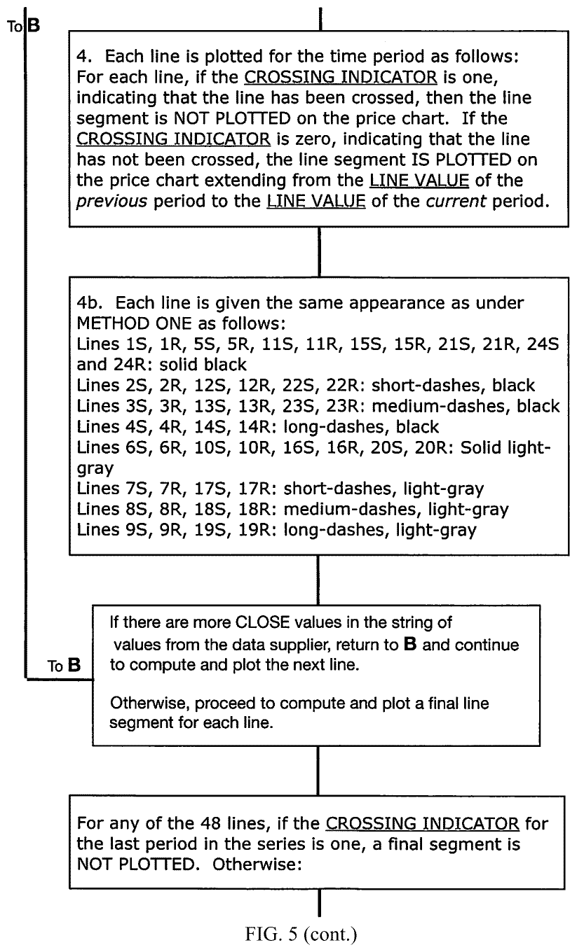

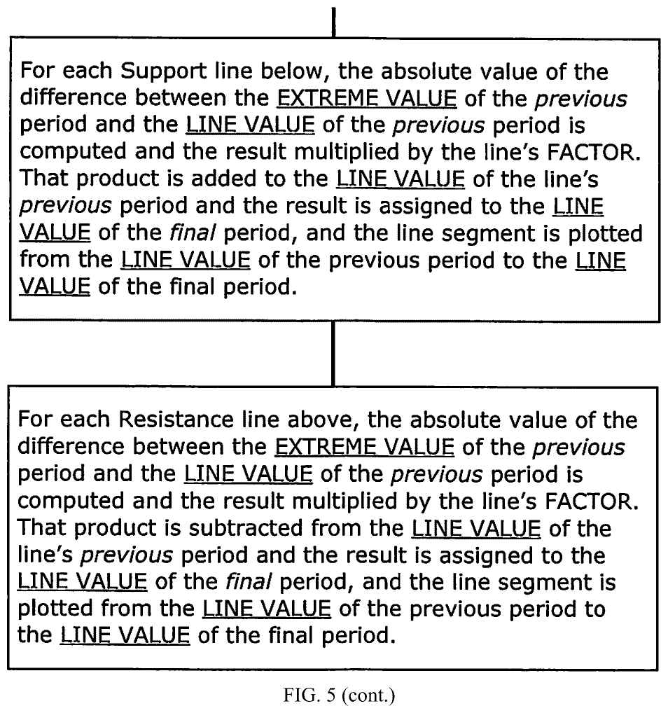

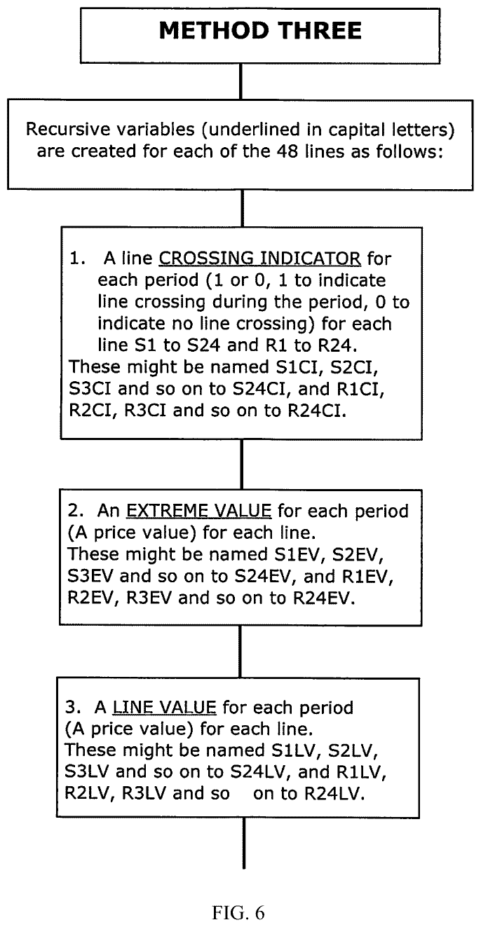

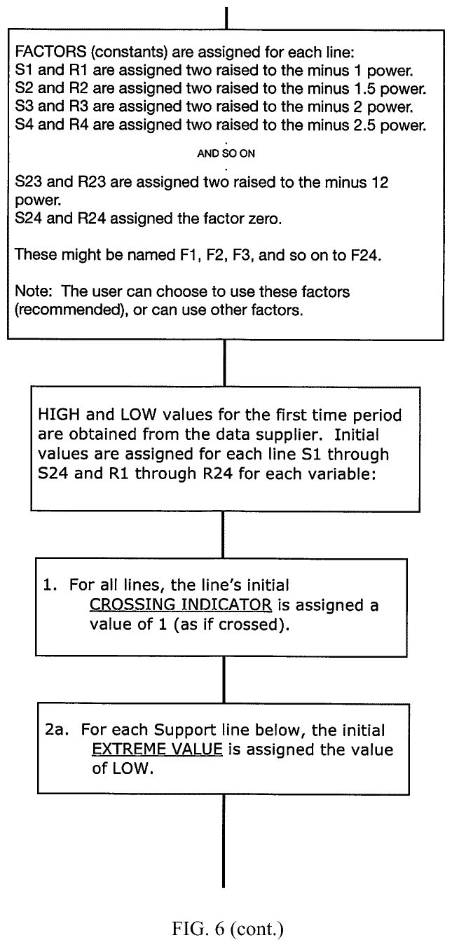

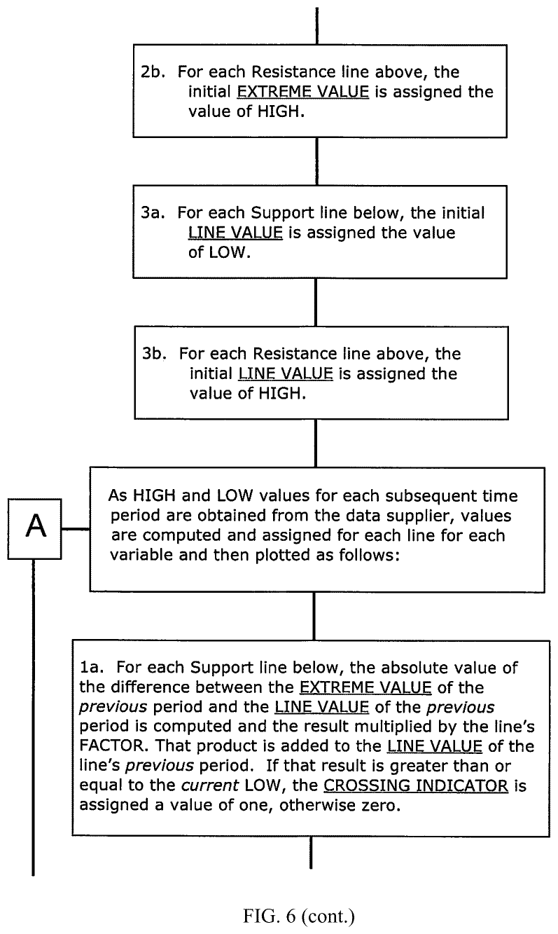

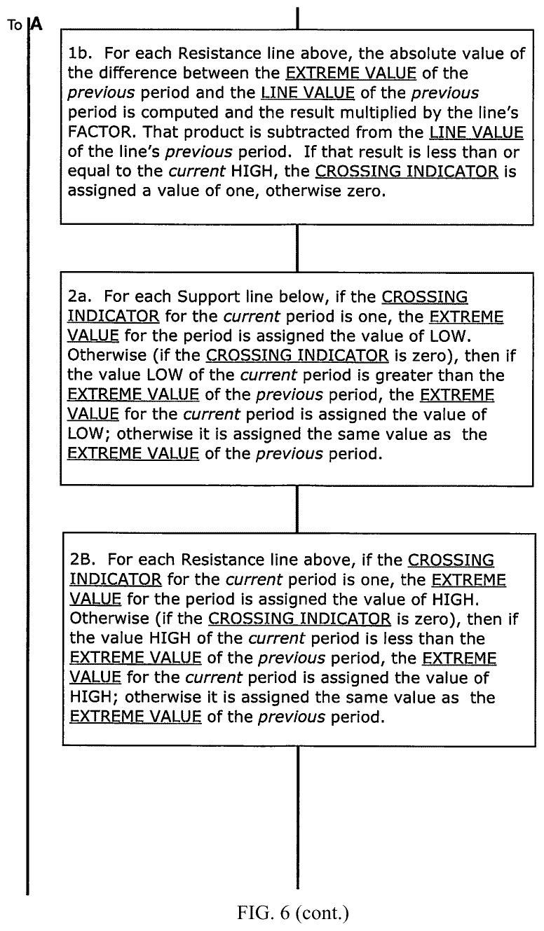

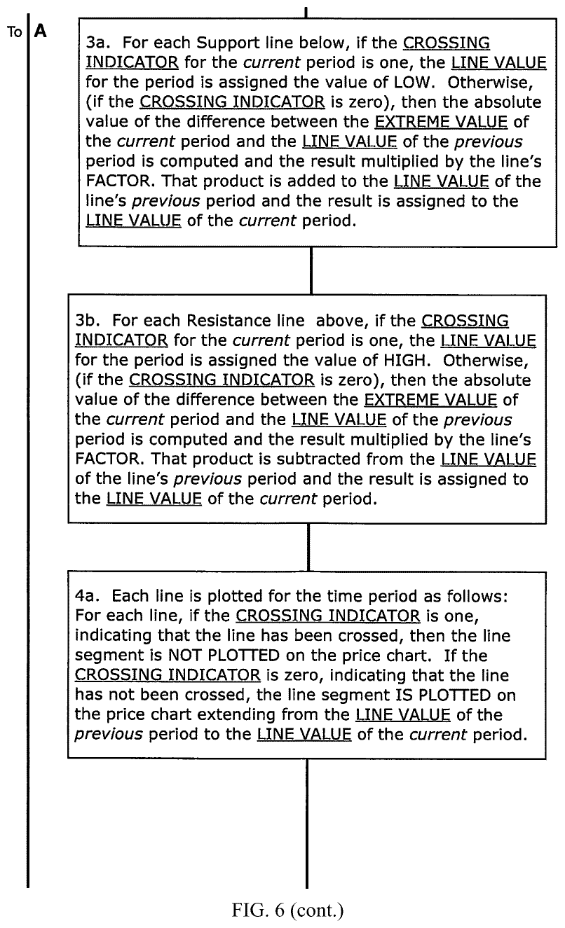

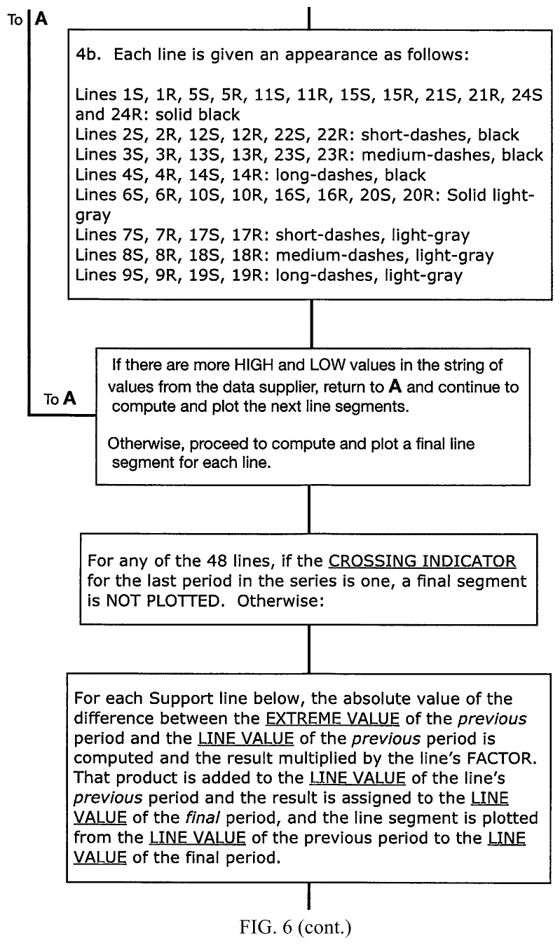

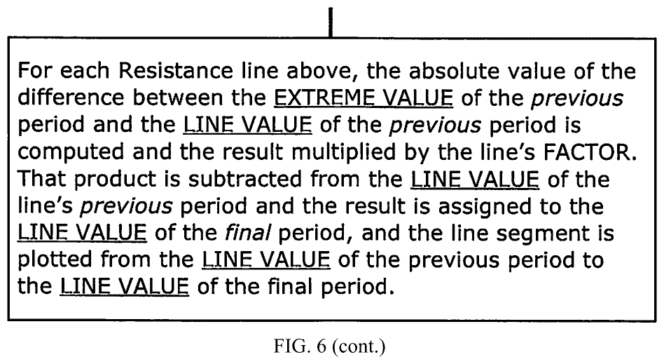

Advantageously, the invention allows for the calculated lines of support or resistance to be plotted in three different ways. It is the user's choice as to which type of chart plot is preferred. Herein, the method of the invention that uses high price values for calculations of support lines and low price values for calculations of resistance lines is referred to as METHOD ONE. See FIG. 5. The calculations illustrated in FIG. 3 are representative of the results of METHOD ONE. Alternatively, the method of the invention that uses only closing values (CLOSE) for each time period is referred to as METHOD TWO. See FIG. 5. In a third embodiment of the invention, the method of the invention that uses low price values for calculations of support lines and high price values for calculations of resistance lines and is referred to as METHOD 3. See FIG. 6. As used herein and in the accompanying drawings, the terms “HIGH” and “LOW” refer to the value for an asset, and the term “CLOSE” refers to the closing value of the asset.

The calculations illustrated in FIG. 4 are representative of the results of METHOD TWO, with each price bar representing one week over a two-year period. During the two years period that is shown, each time the price fell, and the tail of a price bar broke the next support line, after which the price turned up and went on to reach a significantly higher price. The lines were broken in exact succession. These results illustrate that methods of the invention successfully yield results that match with what actually occurred. If a user had been able to use the invention to place orders based on the predictive results of the invention, then the user would have succeeded in realizing a profit with each buy order and been able to successfully sell at a profit. Those of skill in the art will appreciate that the invention may not always predict the rise and fall of a stock as perfectly is illustrated in FIG. 4; however, given that the lines correctly predicted profitable buy points 13 timees in a row, these results show that the invention provides improved methods of predicting likely support and resistance levels.

Prices rise and fall in spurts, and traders use various methods to determine the levels at which reversals in direction are likely to occur. Rising prices always eventually turn and fall back. History shows that falling prices, with rare exceptions, such as in the case of a bankruptcy, always reverse and rise. The reversals can occur at any price level, but if one could predict a finite number of levels where a reversal is relatively likely to occur, then a trading strategy based upon those levels could profit in proportion to the accuracy of the predictions.

This invention is based upon a binary rule. While not fully understood the following is hypothesized to explain why the invention is able to better predict the rise and fall of prices as compared to other methods in common use today.

A market for anything is a continuous string of up and down moves (and occasionally no change) for every time period. Call them U for an up move and D for a down move. Start with the assumption that the odds of any given move, U or D, in any given time period chosen are 50-50. The likelihood of a D occurring after just one U has occurred, is one-half. But the likelihood of just one D in a row in a long string of moves randomly generated is much less than one-half because several in a row can occur. With the same appearance as a string of coin-flips, the string of market moves might look like this: U-D-U-U-D-U-D-D-D-U-D-D-U-U-D. No matter the starting point chosen, the probability of any single permutation of the order of next moves for a given number of moves is the same.

For example, consider the next two moves in price. There are four permutations possible, which are UU, UD, DU, or DD. The probability of each is the same, one-fourth. The probability that the price will end up two moves higher is one fourth (UU). The probability that the price will end up with the same number of up and down moves is one-half (UD, DU), and the probability that the price will end up two moves lower (DD) is one-fourth. However, after the first move, the remaining permutations are U, D, U, and D; so the odds of the next move, either up or down, are 50-50.

Next consider the odds for three moves in price. There are eight permutations possible, which are UUU, UUD, UDU, UDD, DUU, DUD, DDU or DDD. The probability for each is one-eighth. There is a one-eighth chance the price will end up three moves higher (UUU); three-eighths chance it will end up one move higher (UUD, UDU, DUU); three-eighths chance it will end up one move lower (UDD, DUD, DDU); and a one-eighth chance it will end up three moves lower (DDD). Again, after the first move, the remaining permutations are UU, UD, DU, DD, UU, UD, DU or DD, and the odds for the remaining two moves at that point are exactly the same as the odds for two moves in a row in the paragraph above.

The same analysis can be carried out for each successive number of moves in the future string of moves, and once each move actually occurs, the odds profile of the remaining moves becomes exactly the same as the odds profile for a string of moves one less in length. Also, consider for example, that after a string of ten up moves in a row, the likelihood of ten down moves in a row is only one out of 1024 (two to the minus tenth power), the factor assigned to lines S19 and R19. Yet it will actually occur randomly every 1024 times.

These odds are reflected in the way the lines are computed by the invention. Each time the price moves up, for example, the first support line below moves halfway to the new higher extreme value, with the result that support line 1 is always an average of one move below the current price, until it is crossed. It is very common in a string of up or down moves to see successive bars cross one resistance or support line with each period.

While price movements may be large or small, advantageously methods of the invention take this variation in movement into account. Thus over the long run, each line is more or less predicted to move an amount that is determined by the amplitude of moves made from its start to the point in time that its ultimate maximum extreme value is set. After that, each line moves a set fraction of the remaining distance, never quite reaching its extreme, and eventually being crossed by the price (except for lines S24 and R24, which are horizontal, reflecting all times highs and lows.)

Those of skill in the art will appreciate that if one assumes that the amplitude of a given up or down move remains close to a constant value, then when considering an odd number of moves in a row, it would not be possible for the price to end up where it started; in contrast when considering an even number of moves, it would be possible for the price to end up where it started. This fact may or may not explain why the lines with factors in between one-half, one-fourth, one-eighth, and so on, actually work. But the eye can see that they do in fact work, by studying many charts.

This invention provides a better estimation of where the levels of support and resistance are likely to be than the methods in common use today.

The invention, being based on a binary rule, with each line in a family of lines having successively smaller and smaller factors, makes the retracement from peak to peak and trough to trough in price easy to see. Each next support and resistance line embodies the base two estimate of how many trading periods that the line is likely to require before the price crosses it, as the actual permutation of U's and D's is determined in time.

The invention computes and displays support and resistance levels where reversals are likely to occur as a result of their innate probability. The invention works as a result of the assumption that price moves are in fact random. But those of skill in the art will recognize that price moves are not necessarily completely random but are more likely to be caused by a mixture of randomness and not randomness. Nevertheless, prices moves are sufficiently random to make the predictive lines yielded by the invention useful, and better at predicting support and resistance levels as compared to current methods.

Asset prices are moved by many outside influences, such as prevailing trader sentiment, company news, black swan events, announcements by the United States Federal Reserve, as well as other market influences. But in the absence of such exceptional influences, prices do move in a random fashion, and reverse direction with a binary pattern. The graphic results provided by the invention reflect the random component. The non-random influences introduce error into the computing of the probability of levels support and resistance, and these non-random influences can cause the predictive results of the invention to be less accurate.

The predictive value of the lines produced by the invention is easy to see on almost any price chart. Price reversals tend to occur at successive line crossings. For example, after a price has reversed at line 9, it is more likely to next reverse at line 10. Further, in between such reversals, sequential reversals between smaller-numbered lines also commonly occur. These sequential reversals are all the result of the relative probability predictions that are embodied in the invention. But it is always possible for improbable events to occur, as in the 1 in 1024 chance for ten U's or ten D's to occur in a row once every 1024 times previously referenced. Such events of multiple moves in a row do happen, and prices do skip across several lines before reversing with the same probabilities.

As additional examples of the successful application of the invention, the daily charts, of the most prominent stocks, all for the same time period, are presented in FIGS. 7-12. They are presented to illustrate the frequency of sequential reversals, the frequency of reversals right at a line, and especially how price often pauses, even for one or two bars, very close to when price meets a new line of support or resistance.

Unless defined otherwise, all technical and scientific terms used herein have the same meaning as is commonly understood by one of skill in the art to which this invention belongs at the time of filing. In particular, as used herein the terms “support” and “resistance” are terms for respective levels on a price chart that appear to limit the market's range of movement. The support level is where the price is likely to stop falling and bounce back up, while the resistance level is where the price is likely to stop rising and dip back down.

Terminology used herein is for the purpose of describing particular embodiments of the invention and is not intended to be limiting. The meaning and scope of terms should be clear; however, in the event of any latent ambiguity, definitions provided herein take precedent over any dictionary or extrinsic definition. Further, unless otherwise required by context, singular terms shall include pluralities and plural terms shall include the singular unless the content clearly dictates otherwise. Herein, the use of “or” means “and/or” unless stated otherwise. Furthermore, the use of the term “including”, as well as other forms such as “includes” and “included” is not limiting. As used herein, “each” refers to each member of a set or each member of a subset of a set.

What is claimed is:

1. An improved computer-based method for analyzing stock and securities pricing information, comprising
a. coupling a processor or microprocessor to a memory and a display, wherein the processor or microprocessor is programmed to receive price values for a stock or a security;
b. receiving a set of initial price values for the stock or security that comprise a high price value and a low price value at which the stock or security traded during an initial time period;
c. creating a support line variable and a resistance line variable, wherein the support line variable and the resistance line variable are recursive;
d. creating a crossing indicator variable and an extreme variable for the support line variable and a crossing indicator variable and an extreme variable for the resistance line variable, wherein each crossing indicator variable and each extreme variable is recursive;
e. selecting an associated factor for the support line variable and an associated factor for the resistance line variable, wherein each associated factor is selected from a group of values between zero and one inclusively, and the values of the associated factor for the support line variable and the resistance line variable are the same;
f. giving each crossing indicator variable a value of 1 for the initial time period;
g. using the set of initial price values to give the extreme variable for the support line variable an assigned received high price value for the initial time period;
h. using the set of initial price values to give the extreme variable for the resistance line variable a designated received low price value for the initial time period;
i. using the set of initial price values to give the support line variable an assigned received low price value for the initial time period;
j. using the set of initial price values to give the resistance line variable a designated received high price value for the initial time period;
k. receiving at least one set of subsequent price values for the stock or security that comprises the high price value and the low price value at which the stock or security traded during a subsequent time period;
l. using the set of subsequent price values to compute a subsequent support line segment and a subsequent resistance line segment for a current time period, wherein the subsequent support line segment and the subsequent resistance line segment comprise values computed respectively for the support line variable and the resistance line variable, and plotting a graphical temporal display of the support line and the resistance line for at least one previous time period and the current time period;
m. using the set of subsequent price values to give the crossing indicator variable for the support line variable an assigned value of zero or one for the current time period, wherein an absolute value of the difference between the assigned value given to the extreme variable for the support line variable for an immediately preceding time period and the assigned value given to the support line variable for the immediately preceding time period is calculated to yield an assigned result that is multiplied by the associated factor given to the support line variable to yield an assigned product that is added to the assigned value given to the support line variable from the immediately preceding time period to yield a projected support line value such that if the projected support line value is greater than or equal to the assigned received low price value for the current time period, then the crossing indicator variable for the support line variable is given the assigned value of one for the current time period, and if the projected support line value is less than the assigned received low price value for the current time period, then the crossing indicator variable for the support line variable is given the value of zero for the current time period;
n. using the set of subsequent price values to give to the crossing indicator variable for the resistance line variable a designated value of zero or one for the current time period, wherein an absolute value of the difference between the designated value given to the extreme variable for the resistance line variable for the immediately preceding time period and the designated value given to the resistance line variable for the immediately preceding time period is calculated to yield a designated result that is multiplied by the associated factor given to the resistance line variable to yield a designated product that is subtracted from the designated value given to the resistance line variable for the immediately preceding time period to yield a projected resistance line value such that if the projected resistance line value is less than or equal to the designated received high price value, then the crossing indicator variable for the resistance line variable is given the designated value of one for the current time period, and if the projected resistance line value is greater than the designated received high price value, then the crossing indicator variable for the resistance line variable is given the value of zero for the current time period;
o. using the set of subsequent price values to give to the extreme variable for the support line variable an assigned value for the current time period, wherein if the crossing indicator variable for the support line variable was given the assigned value of one for the current time period, then the extreme variable for the support line variable is given the assigned received high price value for the current time period, and if the crossing indicator variable for the support line variable was given a value of zero for the current time period, then if the assigned received high price value for the current time period is greater than the assigned value for the extreme variable for the support line variable for the immediately preceding time period, then the extreme variable for the current time period is given the assigned received high price value, and if the assigned received high price value for the current time period is less than or equal to the assigned value given to the extreme variable for the support line variable for the immediately preceding time period, then the extreme variable for the support line variable is given the same assigned value for the current time period as was given to the extreme variable for the support line variable for the immediately preceding time period;
p. using the set of subsequent price values to give to the extreme variable for the resistance line variable a designated current value for the current time period such that if the crossing indicator variable for the resistance line variable was given the designated value of one for the current time period, then the extreme variable for the resistance line variable is given a designated received low price value for the current time period, and if the crossing indicator variable for the resistance line variable was given the designated value of zero for the current time period, then if the designated received low price value for the current time period is less than the designated value given to the extreme variable for the resistance line variable for the immediately preceding time period, then the extreme variable for the resistance line variable for the current time period is given the designated received low price value, and if the designated received low price value for the current time period is greater than or equal to the designated value given for the extreme variable for the resistance line variable for the immediately preceding time period, then the extreme variable for the resistance line variable is given the same value for the current time period as was given to the extreme variable for the resistance line variable for the immediately preceding time period;
q. using the set of subsequent price values to give to the support line variable an assigned value for the current time period such that if the crossing indicator variable for the support line variable was given the assigned value of one for the current time period, then the support line variable is given the assigned received low price value for the current time period, and if the crossing indicator variable for the support line variable was given the assigned value of zero for the current time period, then the absolute value of the difference between the assigned value given to the extreme variable for the support line variable for the current time period and the assigned value given to the support line variable for the immediately preceding time period is calculated to yield an assigned result that is multiplied by the associated factor given to the support line variable to yield an assigned product that is added to the assigned value given to the support line variable for the immediately preceding time period to yield an assigned final result that is given to the support line variable for the current time period;
r. using the set of subsequent price values to give to the resistance line variable a designated value for the current time period such that if the crossing indicator variable for the resistance line variable was given the designated value of one for the current time period, then the resistance line variable is given the designated received high price value for the current time period, and if the crossing indicator variable for the resistance line variable was given a designated value of zero for the current time period, then the absolute value of the difference between the designated value given to the extreme variable for the resistance line variable for the current time period and the designated value given to the resistance line variable for the immediately preceding time period is calculated to yield a designated result that is multiplied by the associated factor given to the resistance line variable to yield a designated product that is subtracted from the designated value given to the resistance line variable for the immediately preceding time period to yield a designated final result that is given to the resistance line variable for the current time period; and
s. plotting a subsequent support line segment for the support line variable and a subsequent resistance line segment for the resistance line variable on a price chart such that for the support line variable and the resistance line variable if the respective crossing indicator variable was given a value of one for the current time period, then the support line segment or the resistance line segment is not plotted on the price chart for the current time period, and if the respective crossing indicator variable was given a value of zero for the current time period, then the subsequent support line segment or the subsequent resistance line segment is plotted on the price chart for the current time period such that the subsequent support line segment is plotted to extend from the assigned value given to the support line variable for the immediately preceding time period to the assigned value given to the support line variable for the current time period, and the subsequent resistance line segment is plotted to extend from the designated value given to the resistance line variable for the immediately preceding time period to the designated value given to the resistance line variable for the current time period.

2. The improved computer-based method for analyzing stock and securities pricing information of claim 1, wherein the initial period of time consists of minutes, hours, days, weeks, months, years, or a combination thereof, and the subsequent period of time consists of minutes, hours, days, weeks, months, years, or a combination thereof.

3. The improved computer-based method for analyzing stock and securities pricing information of claim 1 further comprising
a. receiving at least one additional set of subsequent price values for a stock or security for at least one additional time period wherein each set of subsequent price values for the stock or security comprises a high price value and a low price value at which the stock or security traded during a subsequent time period;
b. using the additional set of subsequent price values to compute a subsequent support line segment and a subsequent resistance line segment for a current time period, wherein the subsequent support line segment and the subsequent resistance line segment comprise values computed for the support line variable and the resistance line variable, and plotting a graphical temporal display of the support line and the resistance line for at least one previous time period and the current time period;
c. using the additional set of subsequent price values to give to the crossing indicator variable for the support line variable an assigned value of zero or one for the current time period, wherein an absolute value of the difference between the assigned value given to the extreme variable for the support line variable for an immediately preceding time period and the assigned value given to the support line variable for the immediately preceding time period is calculated to yield an assigned result that is multiplied by the associated factor given to the support line variable to yield an assigned product that is added to the assigned value given to the support line variable for the immediately preceding time period to yield a projected support line value such that if the projected support line value is greater than or equal to the assigned received low price value for the current time period, then the crossing indicator variable for the support line variable is given the assigned value of one for the current time period, and if the projected support line value is less than the assigned received low price value for the current time period, then the crossing indicator variable for the support line variable is given the assigned value of zero for the current time period;
d. using the additional set of subsequent price values to give to the crossing indicator variable for the resistance line variable a designated value of zero or one for the current time period, wherein the absolute value of the difference between the designated value given to the extreme variable for the resistance line variable for the immediately preceding time period and the designated value given to the resistance line variable for the immediately preceding time period is calculated to yield a designated result that is multiplied by the associated factor given to the resistance line variable to yield a designated product that is subtracted from the designated value given to the resistance line variable for the immediately preceding time period to yield a projected resistance line value such that if the projected resistance line value is less than or equal to the designated received high price value, then the crossing indicator variable for the resistance line variable is given the designated value of one for the current time period, and if the projected resistance line value is greater than the designated received high price value, then the crossing indicator variable for the resistance line variable is given the designated value of zero for the current time period;
e. using the additional set of subsequent price values to give to the extreme variable for each support line variable the assigned value for the current time period, wherein if the crossing indicator variable for the support line variable was given the assigned value of one for the current time period, then the extreme variable for each support line variable is given the assigned received high price value for the current time period, and if the crossing indicator variable for the support line variable was given the value of zero for the current time period, then if the assigned received high price value for the current time period is greater than the assigned value given to the extreme variable for the support line variable for the immediately preceding time period, then the extreme variable for the support line variable for the current time period is given the assigned received high price value, and if the assigned received high price value for the current time period is less than or equal to the assigned value given to the extreme variable for the support line variable for the immediately preceding time period, then the extreme variable for the support line variable is given the same value for the current time period as was given to the extreme variable for the support line variable for the immediately preceding time period;
f. using the additional set of subsequent price values to give to the extreme variable for the resistance line variable the designated value for the current time period such that if the crossing indicator variable for the resistance line variable was given the designated value of one for the current time period, then the extreme variable for the resistance line variable is given the designated received low price value for the current time period, and if the crossing indicator variable for the resistance line variable was given the value of zero for the current time period, then if the designated received low price value for the current time period is less than the designated value given to the extreme variable for the resistance line variable for the immediately preceding time period, then the extreme variable for the resistance line variable for the current time period is given the designated received low price value, and if the designated received low price value for the current time period is greater than or equal to the designated value given for the extreme variable for the resistance line variable for the immediately preceding time period, then the extreme variable for the resistance line variable is given the same value for the current time period as was given to the extreme variable for the resistance line variable for the immediately preceding time period;
g. using the additional set of subsequent price values to give to the support line variable an assigned value for the current time period such that if the crossing indicator variable for the support line variable was given the assigned value of one for the current time period, then the support line variable is given the assigned received low price value for the current time period, and if the crossing indicator variable for the support line variable was given the assigned value of zero for the current time period, then the absolute value of the difference between the assigned value given to the extreme variable for the support line variable for the current time period and the assigned value given to the support line variable for the immediately preceding time period is calculated to yield an assigned result that is multiplied by the associated factor given to the support line variable to yield an assigned product that is added to the assigned value given to the support line variable for the immediately preceding time period to yield an assigned final result that is given to the support line variable for the current time period;
h. using the additional set of subsequent price values to give to the resistance line variable a designated value for the current time period such that if the crossing indicator variable for the resistance line variable was given the designated value of one for the current time period, then the resistance line variable is given the designated received high price value for the current time period, and if the crossing indicator variable for the resistance line variable was given a designated value of zero for the current time period, then the absolute value of the difference between the designated value given to the extreme variable for the resistance line variable for the current time period and the designated value given to the resistance line variable for the immediately preceding time period is calculated to yield a designated result that is multiplied by the associated factor given to the resistance line variable to yield a designated product that is subtracted from the designated value given to the resistance line variable for the immediately preceding time period to yield a designated final result that is given to the resistance line variable for the current time period; and
i. plotting the subsequent support line segment for the support line variable and the subsequent resistance line segment for the resistance line variable on a price chart such that for the support line variable and the resistance line variable if the respective crossing indicator variable was given a value of one for the current time period, then the support line segment or the resistance line segment is not plotted on the price chart for the current time period, and if the respective crossing indicator variable was given the value of zero for the current time period, then the subsequent support line segment or the subsequent resistance line segment is plotted on the price chart for the current time period such that the subsequent support line segment is plotted to extend from the assigned value given to the support line variable for the immediately preceding time period to the assigned value given to the support line variable for the current time period, and the subsequent resistance line segment is plotted to extend from the designated value given to the resistance line variable for the immediately preceding time period to the designated value given to the resistance line variable for the current time period.

4. The improved computer-based method for analyzing stock and securities pricing information of claim 1 further comprising
a. computing and plotting a final support line segment for a final time period for each support line variable after the subsequent received high price values and the subsequent received low price values are used to calculate and plot the subsequent support line segments, wherein for each support line variable if the respective crossing indicator variable was given the assigned value of one for the immediately preceding time period then the final support line segment for the support line variable is not plotted, and if the respective crossing indicator variable was given the assigned value of zero for the immediately preceding time period then the absolute value of the difference between the assigned value given to the respective extreme variable for the immediately preceding time period and the assigned value given to the support line variable for the immediately preceding time period is calculated and an assigned final result is multiplied by the associated factor given to the support line variable and an assigned final product is added to the assigned value given to the support line variable for the immediately preceding time period, and an assigned final value is given to the support line variable for the final time period;
b. computing and plotting a final resistance line segment for a final time period for each resistance line variable after the subsequent received high price values and the subsequent received low price values are used to calculate and plot subsequent resistance line segments wherein for each resistance line variable if the respective crossing indicator variable was given the designated value of one for the immediately preceding time period then the final resistance line segment for the resistance line variable is not plotted, and if the respective crossing indicator variable was given the designated value of zero for the immediately preceding time period then the absolute value of the difference between the designated value given to the respective extreme variable for the immediately preceding time period and the designated value given to the resistance line variable for the immediately preceding time period is calculated and a designated final result is multiplied by the associated factor given to the resistance line variable and a designated final product is subtracted from the designated value given to the resistance line variable for the immediately preceding time period, and a designated final value is given to the resistance line variable for the final time period; and
c. plotting a final support line segment for the support line variable and a final resistance line segment for the resistance line variable such that if the respective crossing indicator variable for the support line or the resistance line was given the value of one, then the final support line segment or the final resistance line segment is not plotted for a last time period, and if the respective crossing indicator variable for the support line or the resistance line was given the value of zero, then the final support line segment or the final resistance line segment is plotted for the final time period such that the final support line segment for the support line variable is plotted for the last time period to extend from the assigned value given to the support line variable for the immediately preceding time period to the assigned final value given to the support line variable and the final resistance line segment for the resistance line variable is plotted for the last time period to extend from the designated value given to the resistance line variable for the immediately preceding time period to the designated final value given to the resistance line variable.

5. The improved computer-based method for analyzing stock and securities pricing information of claim 3 further comprising
a. computing and plotting a final support line segment for a final time period for each support line variable after the subsequent received high price values and the subsequent received low price values are used to calculate and plot the subsequent support line segments, wherein for each support line variable if the respective crossing indicator variable was given the assigned value of one for the immediately preceding time period then the final support line segment for the support line variable is not plotted, and if the respective crossing indicator variable was given the assigned value of zero for the immediately preceding time period then the absolute value of the difference between the assigned value given to the respective extreme variable for the immediately preceding time period and the assigned value given to the support line variable for the immediately preceding time period is calculated and an assigned final result is multiplied by the associated factor given to the support line variable and an assigned final product is added to the assigned value given to the support line variable for the immediately preceding time period, and an assigned final value is given to the support line variable for the final time period;
b. computing and plotting a final resistance line segment for a final time period for each resistance line variable after the subsequent received high price values and the subsequent received low price values are used to calculate and plot subsequent resistance line segments wherein for each resistance line variable if the respective crossing indicator variable was given the designated value of one for the immediately preceding time period then the final resistance line segment for the resistance line variable is not plotted, and if the respective crossing indicator variable was given the designated value of zero for the immediately preceding time period then the absolute value of the difference between the designated value given to the respective extreme variable for the immediately preceding time period and the designated value given to the resistance line variable for the immediately preceding time period is calculated and a designated final result is multiplied by the associated factor given to the resistance line variable and a designated final product is subtracted from the designated value given to the resistance line variable for the immediately preceding time period, and a designated final value is given to the resistance line variable for the final time period; and
c. plotting a final support line segment for the support line variable and a final resistance line segment for the resistance line variable such that if the respective crossing indicator variable for the support line or the resistance line was given the value of one, then the final support line segment or the final resistance line segment is not plotted for a last time period, and if the respective crossing indicator variable for the support line or the resistance line was given the value of zero, then the final support line segment or the final resistance line segment is plotted for the final time period such that the final support line segment for the support line variable is plotted for the last time period to extend from the assigned value given to the support line variable for the immediately preceding time period to the assigned final value given to the support line variable and the final resistance line segment for the resistance line variable is plotted for the last time period to extend from the designated value given to the resistance line variable for the immediately preceding time period to the designated final value given to the resistance line variable.

6. The improved computer-based method for analyzing stock and securities pricing information of claim 1, wherein the additional set of subsequent price values is used to compute 2 to 49 subsequent support line segments and 2 to 49 subsequent resistance line segments for the current time period or the last time period, and the associated factor is selected from the group consisting of zero and 2 raised to a negative power from minus 1 through minus 12 in increments of one-half.

7. The improved computer-based method for analyzing stock and securities pricing information of claim 3, wherein the additional set of subsequent price values is used to compute 2 to 49 subsequent support line segments and 2 to 49 subsequent resistance line segments for the current time period or the last time period, and the associated factor is selected from the group consisting of zero and 2 raised to a negative power from minus 1 through minus 12 in increments of one-half.

8. An improved computer-based method for analyzing stock and securities pricing information, comprising
a. coupling a processor or microprocessor to a memory and a display, wherein the processor or microprocessor is programmed to receive price values for a stock or a security;
b. receiving a set of initial price values for the stock or security that comprise a high price value and a low price value at which the stock or security traded during an initial time period;
c. creating a support line variable and a resistance line variable, wherein the support line variable and the resistance line variable are recursive;
d. creating a crossing indicator variable and an extreme variable for the support line variable and a crossing indicator variable and an extreme variable for the resistance line variable, wherein each crossing indicator variable and each extreme variable is recursive;
e. selecting an associated factor for the support line variable and an associated factor for the resistance line variable, wherein each associated factor is selected from a group of values between zero and one inclusively, and the values of the respective associated factor for the support line variable and the resistance line variable are the same;
f. giving each crossing indicator variable a value of 1 for the initial time period;
g. using the set of initial price values to give the extreme variable for the support line variable an assigned received low price value for the initial time period;
h. using the set of initial price values to give the extreme variable for the resistance line variable a designated received high price value for the initial time period;
i. using the set of initial price values to give the support line variable an assigned received low price value for the initial time period;
j. using the set of initial price values to give the resistance line variable a designated received high price value for the initial time period;
k. receiving at least one set of subsequent price values for the stock or security that comprises the high price value and the low price value at which the stock or security traded during a subsequent time period;
l. using the set of subsequent price values to compute a subsequent support line segment and a subsequent resistance line segment for a current time period, wherein the subsequent support line segment and the subsequent resistance line segment comprise values computed respectively for the support line variable and the resistance line variable, and plotting a graphical temporal display of the support line and the resistance line for at least one previous time period and the current time period;
m. using the set of subsequent price values to give the crossing indicator variable for the support line variable an assigned value of zero or one for the current time period, wherein an absolute value of the difference between the assigned value given to the extreme variable for the support line variable for an immediately preceding time period and the assigned value given to the support line variable for the immediately preceding time period is calculated to yield an assigned result that is multiplied by the associated factor given to the support line variable to yield an assigned product that is added to the assigned value given to the support line variable from the immediately preceding time period to yield a projected support line value such that if the projected support line value is greater than or equal to the assigned received low price value for the current time period, then the crossing indicator variable for the support line variable is given the assigned value of one for the current time period, and if the projected support line value is less than the assigned received low price value for the current time period, then the crossing indicator variable for the support line variable is given the value of zero for the current time period;
n. using the set of subsequent price values to give to the crossing indicator variable for the resistance line variable a designated value of zero or one for the current time period, wherein an absolute value of the difference between the designated value given to the extreme variable for the resistance line variable for the immediately preceding time period and the designated value given to the resistance line variable for the immediately preceding time period is calculated to yield a designated result that is multiplied by the associated factor given to the resistance line variable to yield a designated product that is subtracted from the designated value given to the resistance line variable for the immediately preceding time period to yield a projected resistance line value such that if the projected resistance line value is less than or equal to the designated received high price value, then the crossing indicator variable for the resistance line variable is given the designated value of one for the current time period, and if the projected resistance line value is greater than the designated received high price value, then the crossing indicator variable for the resistance line variable is given the value of zero for the current time period;
o. using the set of subsequent price values to give to the extreme variable for the support line variable an assigned value for the current time period, wherein if the crossing indicator variable for the support line variable was given the assigned value of one for the current time period, then the extreme variable for the support line variable is given the assigned received low price value for the current time period, and if the crossing indicator variable for the support line variable was given a value of zero for the current time period, then if the assigned received low price value for the current time period is greater than the assigned value for the extreme variable for the support line variable for the immediately preceding time period, then the extreme variable for the current time period is given the assigned received low price value, and if the assigned received low price value for the current time period is less than or equal to the assigned value given to the extreme variable for the support line variable for the immediately preceding time period, then the extreme variable for the support line variable is given the same assigned value for the current time period as was given to the extreme variable for the support line variable for the immediately preceding time period;
p. using the set of subsequent price values to give to the extreme variable for the resistance line variable a designated current value for the current time period such that if the crossing indicator variable for the resistance line variable was given the designated value of one for the current time period, then the extreme variable for the resistance line variable is given a designated received high price value for the current time period, and if the crossing indicator variable for the resistance line variable was given the designated value of zero for the current time period, then if the designated received high price value for the current time period is less than the designated value given to the extreme variable for the resistance line variable for the immediately preceding time period, then the extreme variable for the resistance line variable for the current time period is given the designated received high price value, and if the designated received high price value for the current time period is greater than or equal to the designated value given for the extreme variable for the resistance line variable for the immediately preceding time period, then the extreme variable for the resistance line variable is given the same value for the current time period as was given to the extreme variable for the resistance line variable for the immediately preceding time period;
q. using the set of subsequent price values to give to the support line variable an assigned value for the current time period such that if the crossing indicator variable for the support line variable was given the assigned value of one for the current time period, then the support line variable is given the assigned received low price value for the current time period, and if the crossing indicator variable for the support line variable was given the assigned value of zero for the current time period, then the absolute value of the difference between the assigned value given to the extreme variable for the support line variable for the current time period and the assigned value given to the support line variable for the immediately preceding time period is calculated to yield an assigned result that is multiplied by the associated factor given to the support line variable to yield an assigned product that is added to the assigned value given to the support line variable for the immediately preceding time period to yield an assigned final result that is given to the support line variable for the current time period;
r. using the set of subsequent price values to give to the resistance line variable a designated value for the current time period such that if the crossing indicator variable for the resistance line variable was given the designated value of one for the current time period, then the resistance line variable is given the designated received high price value for the current time period, and if the crossing indicator variable for the resistance line variable was given a designated value of zero for the current time period, then the absolute value of the difference between the designated value given to the extreme variable for the resistance line variable for the current time period and the designated value given to the resistance line variable for the immediately preceding time period is calculated to yield a designated result that is multiplied by the associated factor given to the resistance line variable to yield a designated product that is subtracted from the designated value given to the resistance line variable for the immediately preceding time period to yield a designated final result that is given to the resistance line variable for the current time period; and
s. plotting a subsequent support line segment for the support line variable and a subsequent resistance line segment for the resistance line variable on a price chart such that for the support line variable and the resistance line variable if the respective crossing indicator variable was given a value of one for the current time period, then the support line segment or the resistance line segment is not plotted on the price chart for the current time period, and if the respective crossing indicator variable was given a value of zero for the current time period, then the subsequent support line segment or the subsequent resistance line segment is plotted on the price chart for the current time period such that the subsequent support line segment is plotted to extend from the assigned value given to the support line variable for the immediately preceding time period to the assigned value given to the support line variable for the current time period, and the subsequent resistance line segment is plotted to extend from the designated value given to the resistance line variable for the immediately preceding time period to the designated value given to the resistance line variable for the current time period.

9. The improved computer-based method for analyzing stock and securities pricing information of claim 8, wherein the initial period of time consists of minutes, hours, days, weeks, months, years, or a combination thereof, and the subsequent period of time consists of minutes, hours, days, weeks, months, years, or a combination thereof.

10. The improved computer-based method for analyzing stock and securities pricing information of claim 8 further comprising
a. receiving at least one additional set of subsequent price values for a stock or security for at least one additional time period wherein each set of subsequent price values for the stock or security comprises a high price value and a low price value at which the stock or security traded during a subsequent time period;
b. using the additional set of subsequent price values to compute a subsequent support line segment and a subsequent resistance line segment for a current time period, wherein the subsequent support line segment and the subsequent resistance line segment comprise values computed for the support line variable and the resistance line variable, and plotting a graphical temporal display of the support line and the resistance line for at least one previous time period and the current time period;
c. using the additional set of subsequent price values to give to the crossing indicator variable for the support line variable an assigned value of zero or one for the current time period, wherein an absolute value of the difference between the assigned value given to the extreme variable for the support line variable for an immediately preceding time period and the assigned value given to the support line variable for the immediately preceding time period is calculated to yield an assigned result that is multiplied by the associated factor given to the support line variable to yield an assigned product that is added to the assigned value given to the support line variable for the immediately preceding time period to yield a projected support line value such that if the projected support line value is greater than or equal to the assigned received low price value for the current time period, then the crossing indicator variable for the support line variable is given the assigned value of one for the current time period, and if the projected support line value is less than the assigned received low price value for the current time period, then the crossing indicator variable for the support line variable is given the assigned value of zero for the current time period;
d. using the additional set of subsequent price values to give to the crossing indicator variable for the resistance line variable a designated value of zero or one for the current time period, wherein the absolute value of the difference between the designated value given to the extreme variable for the resistance line variable for the immediately preceding time period and the designated value given to the resistance line variable for the immediately preceding time period is calculated to yield a designated result that is multiplied by the associated factor given to the resistance line variable to yield a designated product that is subtracted from the designated value given to the resistance line variable for the immediately preceding time period to yield a projected resistance line value such that if the projected resistance line value is less than or equal to the designated received high price value, then the crossing indicator variable for the resistance line variable is given the designated value of one for the current time period, and if the projected resistance line value is greater than the designated received high price value, then the crossing indicator variable for the resistance line variable is given the designated value of zero for the current time period;
e. using the additional set of subsequent price values to give to the extreme variable for each support line variable the assigned value for the current time period, wherein if the crossing indicator variable for the support line variable was given the assigned value of one for the current time period, then the extreme variable for each support line variable is given the assigned received low price value for the current time period, and if the crossing indicator variable for the support line variable was given the value of zero for the current time period, then if the assigned received low price value for the current time period is greater than the assigned value given to the extreme variable for the support line variable for the immediately preceding time period, then the extreme variable for the support line variable for the current time period is given the assigned received low price value, and if the assigned received low price value for the current time period is less than or equal to the assigned value given to the extreme variable for the support line variable for the immediately preceding time period, then the extreme variable for the support line variable is given the same value for the current time period as was given to the extreme variable for the support line variable for the immediately preceding time period;
f. using the additional set of subsequent price values to give to the extreme variable for the resistance line variable the designated value for the current time period such that if the crossing indicator variable for the resistance line variable was given the designated value of one for the current time period, then the extreme variable for the resistance line variable is given the designated received high price value for the current time period, and if the crossing indicator variable for the resistance line variable was given the value of zero for the current time period, then if the designated received high price value for the current time period is less than the designated value given to the extreme variable for the resistance line variable for the immediately preceding time period, then the extreme variable for the resistance line variable for the current time period is given the designated received high price value, and if the designated received high price value for the current time period is greater than or equal to the designated value given for the extreme variable for the resistance line variable for the immediately preceding time period, then the extreme variable for the resistance line variable is given the same value for the current time period as was given to the extreme variable for the resistance line variable for the immediately preceding time period;
g. using the additional set of subsequent price values to give to the support line variable an assigned value for the current time period such that if the crossing indicator variable for the support line variable was given the assigned value of one for the current time period, then the support line variable is given the assigned received low price value for the current time period, and if the crossing indicator variable for the support line variable was given the assigned value of zero for the current time period, then the absolute value of the difference between the assigned value given to the extreme variable for the support line variable for the current time period and the assigned value given to the support line variable for the immediately preceding time period is calculated to yield an assigned result that is multiplied by the associated factor given to the support line variable to yield an assigned product that is added to the assigned value given to the support line variable for the immediately preceding time period to yield an assigned final result that is given to the support line variable for the current time period;
h. using the additional set of subsequent price values to give to the resistance line variable a designated value for the current time period such that if the crossing indicator variable for the resistance line variable was given the designated value of one for the current time period, then the resistance line variable is given the designated received high price value for the current time period, and if the crossing indicator variable for the resistance line variable was given a designated value of zero for the current time period, then the absolute value of the difference between the designated value given to the extreme variable for the resistance line variable for the current time period and the designated value given to the resistance line variable for the immediately preceding time period is calculated to yield a designated result that is multiplied by the associated factor given to the resistance line variable to yield a designated product that is subtracted from the designated value given to the resistance line variable for the immediately preceding time period to yield a designated final result that is given to the resistance line variable for the current time period; and
i. plotting the subsequent support line segment for the support line variable and the subsequent resistance line segment for the resistance line variable on a price chart such that for the support line variable and the resistance line variable if the respective crossing indicator variable was given a value of one for the current time period, then the support line segment or the resistance line segment is not plotted on the price chart for the current time period, and if the respective crossing indicator variable was given the value of zero for the current time period, then the subsequent support line segment or the subsequent resistance line segment is plotted on the price chart for the current time period such that the subsequent support line segment is plotted to extend from the assigned value given to the support line variable for the immediately preceding time period to the assigned value given to the support line variable for the current time period, and the subsequent resistance line segment is plotted to extend from the designated value given to the resistance line variable for the immediately preceding time period to the designated value given to the resistance line variable for the current time period.

11. The improved computer-based method for analyzing stock and securities pricing information of claim 8 further comprising
a. computing and plotting a final support line segment for a final time period for each support line variable after the subsequent received high price values and the subsequent received low price values are used to calculate and plot the subsequent support line segments, wherein for each support line variable if the respective crossing indicator variable was given the assigned value of one for the immediately preceding time period then the final support line segment for the support line variable is not plotted, and if the respective crossing indicator variable was given the assigned value of zero for the immediately preceding time period then the absolute value of the difference between the assigned value given to the respective extreme variable for the immediately preceding time period and the assigned value given to the support line variable for the immediately preceding time period is calculated and an assigned final result is multiplied by the associated factor given to the support line variable and an assigned final product is added to the assigned value given to the support line variable for the immediately preceding time period, and an assigned final value is given to the support line variable for the final time period;
b. computing and plotting a final resistance line segment for a final time period for each resistance line variable after the subsequent received high price values and the subsequent received low price values are used to calculate and plot subsequent resistance line segments wherein for each resistance line variable if the respective crossing indicator variable was given the designated value of one for the immediately preceding time period then the final resistance line segment for the resistance line variable is not plotted, and if the respective crossing indicator variable was given the designated value of zero for the immediately preceding time period then the absolute value of the difference between the designated value given to the respective extreme variable for the immediately preceding time period and the designated value given to the resistance line variable for the immediately preceding time period is calculated and a designated final result is multiplied by the associated factor given to the resistance line variable and a designated final product is subtracted from the designated value given to the resistance line variable for the immediately preceding time period, and a designated final value is given to the resistance line variable for the final time period; and
c. plotting a final support line segment for the support line variable and a final resistance line segment for the resistance line variable such that if the respective crossing indicator variable for the support line or the resistance line was given the value of one, then the final support line segment or the final resistance line segment is not plotted for a last time period, and if the respective crossing indicator variable for the support line or the resistance line was given the value of zero, then the final support line segment or the final resistance line segment is plotted for the final time period such that the final support line segment for the support line variable is plotted for the last time period to extend from the assigned value given to the support line variable for the immediately preceding time period to the assigned final value given to the support line variable and the final resistance line segment for the resistance line variable is plotted for the last time period to extend from the designated value given to the resistance line variable for the immediately preceding time period to the designated final value given to the resistance line variable.

12. The improved computer-based method for analyzing stock and securities pricing information of claim 10 further comprising
a. computing and plotting a final support line segment for a final time period for each support line variable after the subsequent received high price values and the subsequent received low price values are used to calculate and plot the subsequent support line segments, wherein for each support line variable if the respective crossing indicator variable was given the assigned value of one for the immediately preceding time period then the final support line segment for the support line variable is not plotted, and if the respective crossing indicator variable was given the assigned value of zero for the immediately preceding time period then the absolute value of the difference between the assigned value given to the respective extreme variable for the immediately preceding time period and the assigned value given to the support line variable for the immediately preceding time period is calculated and an assigned final result is multiplied by the associated factor given to the support line variable and an assigned final product is added to the assigned value given to the support line variable for the immediately preceding time period, and an assigned final value is given to the support line variable for the final time period;
b. computing and plotting a final resistance line segment for a final time period for each resistance line variable after the subsequent received high price values and the subsequent received low price values are used to calculate and plot subsequent resistance line segments wherein for each resistance line variable if the respective crossing indicator variable was given the designated value of one for the immediately preceding time period then the final resistance line segment for the resistance line variable is not plotted, and if the respective crossing indicator variable was given the designated value of zero for the immediately preceding time period then the absolute value of the difference between the designated value given to the respective extreme variable for the immediately preceding time period and the designated value given to the resistance line variable for the immediately preceding time period is calculated and a designated final result is multiplied by the associated factor given to the resistance line variable and a designated final product is subtracted from the designated value given to the resistance line variable for the immediately preceding time period, and a designated final value is given to the resistance line variable for the final time period; and
c. plotting a final support line segment for the support line variable and a final resistance line segment for the resistance line variable such that if the respective crossing indicator variable for the support line or the resistance line was given the value of one, then the final support line segment or the final resistance line segment is not plotted for a last time period, and if the respective crossing indicator variable for the support line or the resistance line was given the value of zero, then the final support line segment or the final resistance line segment is plotted for the final time period such that the final support line segment for the support line variable is plotted for the last time period to extend from the assigned value given to the support line variable for the immediately preceding time period to the assigned final value given to the support line variable and the final resistance line segment for the resistance line variable is plotted for the last time period to extend from the designated value given to the resistance line variable for the immediately preceding time period to the designated final value given to the resistance line variable.

13. The improved computer-based method for analyzing stock and securities pricing information of claim 8, wherein the additional set of subsequent price values is used to compute 2 to 49 subsequent support line segments and 2 to 49 subsequent resistance line segments for the current time period or the last time period, and the associated factor is selected from the group consisting of zero and 2 raised to a negative power from minus 1 through minus 12 in increments of one-half.

14. The improved computer-based method for analyzing stock and securities pricing information of claim 11, wherein the additional set of subsequent price values is used to compute 2 to 49 subsequent support line segments and 2 to 49 subsequent resistance line segments for the current time period or the last time period, and the associated factor is selected from the group consisting of zero and 2 raised to a negative power from minus 1 through minus 12 in increments of one-half.

15. An improved computer-based method for analyzing stock and securities pricing information, comprising
a. coupling a processor or microprocessor to a memory and a display, wherein the processor or microprocessor is programmed to receive price values for a stock or a security;
b. receiving an initial price value for the stock or security that comprise a closing price value at which the stock or security traded during an initial time period;
c. creating a support line variable and a resistance line variable, wherein the support line variable and the resistance line variable are recursive;
d. creating a crossing indicator variable and an extreme variable for the support line variable and a crossing indicator variable and an extreme variable for the resistance line variable, wherein each crossing indicator variable and each extreme variable is recursive;
e. selecting an associated factor for the support line variable and an associated factor for the resistance line variable, wherein each associated factor is selected from a group of values between zero and one inclusively, and the values of the associated factor for the support line variable and the resistance line variable are the same;
f. giving each crossing indicator variable a value of 1 for the initial time period;
g. using the initial price value to give the extreme variable for the support line variable an assigned received closing price value for the initial time period;
h. using the initial price value to give the extreme variable for the resistance line variable a designated received closing price value for the initial time period;
i. using the initial price value to give the support line variable an assigned received closing price value for the initial time period;
j. using the initial price value to give the resistance line variable a designated received closing price value for the initial time period;
k. receiving at least one set of subsequent price values for the stock or security that comprises the closing price value at which the stock or security traded during a subsequent time period;
l. using the set of subsequent price values to compute a subsequent support line segment and a subsequent resistance line segment for a current time period, wherein the subsequent support line segment and the subsequent resistance line segment comprise values computed respectively for the support line variable and the resistance line variable, and plotting a graphical temporal display of the support line segment and the resistance line segment for at least one previous time period and the current time period;
m. using the subsequent price value to give the crossing indicator variable for the support line variable an assigned value of zero or one for the current time period, wherein an absolute value of the difference between the assigned value given to the extreme variable for the support line variable for an immediately preceding time period and the assigned value given to the support line variable for the immediately preceding time period is calculated to yield an assigned result that is multiplied by the associated factor given to the support line variable to yield an assigned product that is added to the assigned value given to the support line variable from the immediately preceding time period to yield a projected support line value such that if the projected support line value is greater than or equal to the assigned received closing price value for the current time period, then the crossing indicator variable for the support line variable is given the assigned value of one for the current time period, and if the projected support line value is less than the assigned received closing price value for the current time period, then the crossing indicator variable for the support line variable is given the value of zero for the current time period;
n. using the set of subsequent price values to give to the crossing indicator variable for the resistance line variable a designated value of zero or one for the current time period, wherein an absolute value of the difference between the designated value given to the extreme variable for the resistance line variable for the immediately preceding time period and the designated value given to the resistance line variable for the immediately preceding time period is calculated to yield a designated result that is multiplied by the associated factor given to the resistance line variable to yield a designated product that is subtracted from the designated value given to the resistance line variable for the immediately preceding time period to yield a projected resistance line value such that if the projected resistance line value is less than or equal to the designated received closing price value, then the crossing indicator variable for the resistance line variable is given the designated value of one for the current time period, and if the projected resistance line value is greater than the designated received closing price value, then the crossing indicator variable for the resistance line variable is given the value of zero for the current time period;
o. using the set of subsequent price values to give to the extreme variable for the support line variable an assigned value for the current time period, wherein if the crossing indicator variable for the support line variable was given the assigned value of one for the current time period, then the extreme variable for the support line variable is given the assigned received closing price value for the current time period, and if the crossing indicator variable for the support line variable was given a value of zero for the current time period, then if the assigned received closing price value for the current time period is greater than the assigned value for the extreme variable for the support line variable for the immediately preceding time period, then the extreme variable for the current time period is given the assigned received closing price value, and if the assigned received closing price value for the current time period is less than or equal to the assigned value given to the extreme variable for the support line variable for the immediately preceding time period, then the extreme variable for the support line variable is given the same assigned value for the current time period as was given to the extreme variable for the support line variable for the immediately preceding time period;
p. using the set of subsequent price values to give to the extreme variable for the resistance line variable a designated current value for the current time period such that if the crossing indicator variable for the resistance line variable was given the designated value of one for the current time period, then the extreme variable for the resistance line variable is given a designated received closing price value for the current time period, and if the crossing indicator variable for the resistance line variable was given the designated value of zero for the current time period, then if the designated received closing price value for the current time period is less than the designated value given to the extreme variable for the resistance line variable for the immediately preceding time period, then the extreme variable for the resistance line variable for the current time period is given the designated received closing price value, and if the designated received closing price value for the current time period is greater than or equal to the designated value given for the extreme variable for the resistance line variable for the immediately preceding time period, then the extreme variable for the resistance line variable is given the same value for the current time period as was given to the extreme variable for the resistance line variable for the immediately preceding time period;
q. using the set of subsequent price values to give to the support line variable an assigned value for the current time period such that if the crossing indicator variable for the support line variable was given the assigned value of one for the current time period, then the support line variable is given the assigned received closing price value for the current time period, and if the crossing indicator variable for the support line variable was given the assigned value of zero for the current time period, then the absolute value of the difference between the assigned value given to the extreme variable for the support line variable for the current time period and the assigned value given to the support line variable for the immediately preceding time period is calculated to yield an assigned result that is multiplied by the associated factor given to the support line variable to yield an assigned product that is added to the assigned value given to the support line variable for the immediately preceding time period to yield an assigned final result that is given to the support line variable for the current time period;
r. using the set of subsequent price values to give to the resistance line variable a designated value for the current time period such that if the crossing indicator variable for the resistance line variable was given the designated value of one for the current time period, then the resistance line variable is given the designated received closing price value for the current time period, and if the crossing indicator variable for the resistance line variable was given a designated value of zero for the current time period, then the absolute value of the difference between the designated value given to the extreme variable for the resistance line variable for the current time period and the designated value given to the resistance line variable for the immediately preceding time period is calculated to yield a designated result that is multiplied by the associated factor given to the resistance line variable to yield a designated product that is subtracted from the designated value given to the resistance line variable for the immediately preceding time period to yield a designated final result that is given to the resistance line variable for the current time period; and
s. plotting a subsequent support line segment for the support line variable and a subsequent resistance line segment for the resistance line variable on a price chart such that for the support line variable and the resistance line variable if the respective crossing indicator variable was given a value of one for the current time period, then the support line segment or the resistance line segment is not plotted on the price chart for the current time period, and if the respective crossing indicator variable was given a value of zero for the current time period, then the subsequent support line segment or the subsequent resistance line segment is plotted on the price chart for the current time period such that the subsequent support line segment is plotted to extend from the assigned value given to the support line variable for the immediately preceding time period to the assigned value given to the support line variable for the current time period, and the subsequent resistance line segment is plotted to extend from the designated value given to the resistance line variable for the immediately preceding time period to the designated value given to the resistance line variable for the current time period.

16. The improved computer-based method for analyzing stock and securities pricing information of claim 15, wherein the initial period of time consists of minutes, hours, days, weeks, months, years, or a combination thereof, and the subsequent period of time consists of minutes, hours, days, weeks, months, years, or a combination thereof.

17. The improved computer-based method for analyzing stock and securities pricing information of claim 15 further comprising
a. receiving at least one additional set of subsequent price values for a stock or security for at least one additional time period wherein each set of subsequent price values for the stock or security comprises a closing price value at which the stock or security traded during a subsequent time period;
b. using the subsequent price value to compute a subsequent support line segment and a subsequent resistance line segment for a current time period, wherein the subsequent support line segment and the subsequent resistance line segment comprise values computed for the support line variable and the resistance line variable, and plotting a graphical temporal display of the support line and the resistance line for at least one previous time period and the current time period;
c. using the subsequent price value to give to the crossing indicator variable for the support line variable an assigned value of zero or one for the current time period, wherein an absolute value of the difference between the assigned value given to the extreme variable for the support line variable for an immediately preceding time period and the assigned value given to the support line variable for the immediately preceding time period is calculated to yield an assigned result that is multiplied by the associated factor given to the support line variable to yield an assigned product that is added to the assigned value given to the support line variable for the immediately preceding time period to yield a projected support line value such that if the projected support line value is greater than or equal to the assigned received closing price value for the current time period, then the crossing indicator variable for the support line variable is given the assigned value of one for the current time period, and if the projected support line value is less than the assigned received closing price value for the current time period, then the crossing indicator variable for the support line variable is given the assigned value of zero for the current time period;
d. using the additional set of subsequent price values to give to the crossing indicator variable for the resistance line variable a designated value of zero or one for the current time period, wherein the absolute value of the difference between the designated value given to the extreme variable for the resistance line variable for the immediately preceding time period and the designated value given to the resistance line variable for the immediately preceding time period is calculated to yield a designated result that is multiplied by the associated factor given to the resistance line variable to yield a designated product that is subtracted from the designated value given to the resistance line variable for the immediately preceding time period to yield a projected resistance line value such that if the projected resistance line value is less than or equal to the designated received closing price value, then the crossing indicator variable for the resistance line variable is given the designated value of one for the current time period, and if the projected resistance line value is greater than the designated received closin price value, then the crossing indicator variable for the resistance line variable is given the designated value of zero for the current time period;
e. using the subsequent price value to give to the extreme variable for each support line variable the assigned value for the current time period, wherein if the crossing indicator variable for the support line variable was given the assigned value of one for the current time period, then the extreme variable for each support line variable is given the assigned received closing price value for the current time period, and if the crossing indicator variable for the support line variable was given the value of zero for the current time period, then if the assigned received closing price value for the current time period is greater than the assigned value given to the extreme variable for the support line variable for the immediately preceding time period, then the extreme variable for the support line variable for the current time period is given the assigned received closin price value, and if the assigned received closing price value for the current time period is less than or equal to the assigned value given to the extreme variable for the support line variable for the immediately preceding time period, then the extreme variable for the support line variable is given the same value for the current time period as was given to the extreme variable for the support line variable for the immediately preceding time period;
f. using the subsequent price value to give to the extreme variable for the resistance line variable the designated value for the current time period such that if the crossing indicator variable for the resistance line variable was given the designated value of one for the current time period, then the extreme variable for the resistance line variable is given the designated received closing price value for the current time period, and if the crossing indicator variable for the resistance line variable was given the value of zero for the current time period, then if the designated received closing price value for the current time period is less than the designated value given to the extreme variable for the resistance line variable for the immediately preceding time period, then the extreme variable for the resistance line variable for the current time period is given the designated received closing price value, and if the designated received closing price value for the current time period is greater than or equal to the designated value given for the extreme variable for the resistance line variable for the immediately preceding time period, then the extreme variable for the resistance line variable is given the same value for the current time period as was given to the extreme variable for the resistance line variable for the immediately preceding time period;
g. using the subsequent price value to give to the support line variable an assigned value for the current time period such that if the crossing indicator variable for the support line variable was given the assigned value of one for the current time period, then the support line variable is given the assigned received closing price value for the current time period, and if the crossing indicator variable for the support line variable was given the assigned value of zero for the current time period, then the absolute value of the difference between the assigned value given to the extreme variable for the support line variable for the current time period and the assigned value given to the support line variable for the immediately preceding time period is calculated to yield an assigned result that is multiplied by the associated factor given to the support line variable to yield an assigned product that is added to the assigned value given to the support line variable for the immediately preceding time period to yield an assigned final result that is given to the support line variable for the current time period;
h. using the subsequent price value to give to the resistance line variable a designated value for the current time period such that if the crossing indicator variable for the resistance line variable was given the designated value of one for the current time period, then the resistance line variable is given the designated received closing price value for the current time period, and if the crossing indicator variable for the resistance line variable was given a designated value of zero for the current time period, then the absolute value of the difference between the designated value given to the extreme variable for the resistance line variable for the current time period and the designated value given to the resistance line variable for the immediately preceding time period is calculated to yield a designated result that is multiplied by the associated factor given to the resistance line variable to yield a designated product that is subtracted from the designated value given to the resistance line variable for the immediately preceding time period to yield a designated final result that is given to the resistance line variable for the current time period; and
i. plotting the subsequent support line segment for the support line variable and the subsequent resistance line segment for the resistance line variable on a price chart such that for the support line variable and the resistance line variable if the respective crossing indicator variable was given a value of one for the current time period, then the support line segment or the resistance line segment is not plotted on the price chart for the current time period, and if the respective crossing indicator variable was given the value of zero for the current time period, then the subsequent support line segment or the subsequent resistance line segment is plotted on the price chart for the current time period such that the subsequent support line segment is plotted to extend from the assigned value given to the support line variable for the immediately preceding time period to the assigned value given to the support line variable for the current time period, and the subsequent resistance line segment is plotted to extend from the designated value given to the resistance line variable for the immediately preceding time period to the designated value given to the resistance line variable for the current time period.

18. The improved computer-based method for analyzing stock and securities pricing information of claim 15 further comprising
a. computing and plotting a final support line segment for a final time period for each support line variable after the subsequent received high price values and the subsequent received low price values are used to calculate and plot the subsequent support line segments, wherein for each support line variable if the respective crossing indicator variable was given the assigned value of one for the immediately preceding time period then the final support line segment for the support line variable is not plotted, and if the respective crossing indicator variable was given the assigned value of zero for the immediately preceding time period then the absolute value of the difference between the assigned value given to the respective extreme variable for the immediately preceding time period and the assigned value given to the support line variable for the immediately preceding time period is calculated and an assigned final result is multiplied by the associated factor given to the support line variable and an assigned final product is added to the assigned value given to the support line variable for the immediately preceding time period, and an assigned final value is given to the support line variable for the final time period;
b. computing and plotting a final resistance line segment for a final time period for each resistance line variable after the subsequent received high price values and the subsequent received low price values are used to calculate and plot subsequent resistance line segments wherein for each resistance line variable if the respective crossing indicator variable was given the designated value of one for the immediately preceding time period then the final resistance line segment for the resistance line variable is not plotted, and if the respective crossing indicator variable was given the designated value of zero for the immediately preceding time period then the absolute value of the difference between the designated value given to the respective extreme variable for the immediately preceding time period and the designated value given to the resistance line variable for the immediately preceding time period is calculated and a designated final result is multiplied by the associated factor given to the resistance line variable and a designated final product is subtracted from the designated value given to the resistance line variable for the immediately preceding time period, and a designated final value is given to the resistance line variable for the final time period; and
c. plotting a final support line segment for the support line variable and a final resistance line segment for the resistance line variable such that if the respective crossing indicator variable for the support line or the resistance line was given the value of one, then the final support line segment or the final resistance line segment is not plotted for a last time period, and if the respective crossing indicator variable for the support line or the resistance line was given the value of zero, then the final support line segment or the final resistance line segment is plotted for the final time period such that the final support line segment for the support line variable is plotted for the last time period to extend from the assigned value given to the support line variable for the immediately preceding time period to the assigned final value given to the support line variable and the final resistance line segment for the resistance line variable is plotted for the last time period to extend from the designated value given to the resistance line variable for the immediately preceding time period to the designated final value given to the resistance line variable.

19. The improved computer-based method for analyzing stock and securities pricing information of claim 17 further comprising
a. computing and plotting a final support line segment for a final time period for each support line variable after the subsequent received high price values and the subsequent received low price values are used to calculate and plot the subsequent support line segments, wherein for each support line variable if the respective crossing indicator variable was given the assigned value of one for the immediately preceding time period then the final support line segment for the support line variable is not plotted, and if the respective crossing indicator variable was given the assigned value of zero for the immediately preceding time period then the absolute value of the difference between the assigned value given to the respective extreme variable for the immediately preceding time period and the assigned value given to the support line variable for the immediately preceding time period is calculated and an assigned final result is multiplied by the associated factor given to the support line variable and an assigned final product is added to the assigned value given to the support line variable for the immediately preceding time period, and an assigned final value is given to the support line variable for the final time period;
b. computing and plotting a final resistance line segment for a final time period for each resistance line variable after the subsequent received high price values and the subsequent received low price values are used to calculate and plot subsequent resistance line segments wherein for each resistance line variable if the respective crossing indicator variable was given the designated value of one for the immediately preceding time period then the final resistance line segment for the resistance line variable is not plotted, and if the respective crossing indicator variable was given the designated value of zero for the immediately preceding time period then the absolute value of the difference between the designated value given to the respective extreme variable for the immediately preceding time period and the designated value given to the resistance line variable for the immediately preceding time period is calculated and a designated final result is multiplied by the associated factor given to the resistance line variable and a designated final product is subtracted from the designated value given to the resistance line variable for the immediately preceding time period, and a designated final value is given to the resistance line variable for the final time period; and
c. plotting a final support line segment for the support line variable and a final resistance line segment for the resistance line variable such that if the respective crossing indicator variable for the support line or the resistance line was given the value of one, then the final support line segment or the final resistance line segment is not plotted for a last time period, and if the respective crossing indicator variable for the support line or the resistance line was given the value of zero, then the final support line segment or the final resistance line segment is plotted for the final time period such that the final support line segment for the support line variable is plotted for the last time period to extend from the assigned value given to the support line variable for the immediately preceding time period to the assigned final value given to the support line variable and the final resistance line segment for the resistance line variable is plotted for the last time period to extend from the designated value given to the resistance line variable for the immediately preceding time period to the designated final value given to the resistance line variable.

20. The improved computer-based method for analyzing stock and securities pricing information of claim 15, wherein the additional set of subsequent price values is used to compute 2 to 49 subsequent support line segments and 2 to 49 subsequent resistance line segments for the current time period or the last time period, and the associated factor is selected from the group consisting of zero and 2 raised to a negative power from minus 1 through minus 12 in increments of one-half.

21. The improved computer-based method for analyzing stock and securities pricing information of claim 17, wherein the additional set of subsequent price values is used to compute 2 to 49 subsequent support line segments and 2 to 49 subsequent resistance line segments for the current time period or the last time period, and the associated factor is selected from the group consisting of zero and 2 raised to a negative power from minus 1 through minus 12 in increments of one-half.
